(19) United States
(12) Patent Application Publication
(10) Pub. No.: US 2021/0218728 A1
(43) Pub. Date: Jul. 15, 2021

(54) COMMUNICATION DEVICE, DATA STRUCTURE, COMMUNICATION METHOD, AND COMPUTER PROGRAM

(71) Applicant: SONY CORPORATION, TOKYO (JP)

(72) Inventors: RYOTA KIMURA, TOKYO (JP); HIROAKI TAKANO, SAITAMA (JP); HIROFUMI KASAI, KANAGAWA (JP); RYO SAWAI, TOKYO (JP); FUMIO TERAOKA, KANAGAWA (JP)

(21) Appl. No.: 16/768,820

(22) PCT Filed: Nov. 30, 2018
(86) PCT No.: PCT/JP2018/044167

§ 371 Date: Jun. 1, 2020

(30) Foreign Application Priority Data
Dec. 11, 2017 (JP) 2017-236882
Oct. 25, 2018 (JP) 2018-201089

(51) Int. Cl. H04L 29/06; H04L 12/707

(52) U.S. Cl. CPC H04L 63/0823; H04L 63/0884; H04L 45/22; H04L 45/24; H04L 63/20

(57) ABSTRACT

[Problem] A communication device is provided that enables one or more functions desired by a service user to act on a packet desired by the service user, in a service of forwarding packets in a network. [Solution] The communication device includes a communication unit configured to execute communication with another node and a control unit configured to control communication by the communication unit. The control unit generates path information to a target node. In the path information to the target node, at least information on at least one relay node present on a path to the target node and information on a function to be executed by the relay node are described.

### FIELD

The present disclosure relates to a communication device, a data structure, a communication method, and a computer program.

### BACKGROUND

From the viewpoint of network operators and service providers, a packet forwarded in a network is forwarded to a server device not included in the original packet forwarding path, if necessary, and a Service Function (SF) operating on the server device acts on the packet. This is called Service Function Chaining (SFC). Examples of SF include Network Address Translation (NAT), Load Balancer, and Web Application Firewall (WAF).

Non Patent Literature 1 discloses an architecture for SFC. Patent Literature 1 discloses a method of performing failure detection and failure recovery of devices and links in an autonomous distributed manner in order to enhance the availability of virtualized network service functions.

### CITATION LIST

### Patent Literature

Patent Literature 1: JP 2016-46736 A

### Non Patent Literature

Non Patent Literature 1: J. Halpern and C. Pignataro. Service Function Chaining (SFC) Architecture, October 2015. RFC 7665.

### SUMMARY

### Technical Problem

In SFC, SFs such as WAF and Load Balancer are prepared from the viewpoint of network operators and service providers. In other words, what packet is targeted by SFC is determined as intended by network operators and service providers.

The present disclosure proposes a new and improved communication device, data structure, communication method, and computer program that enable one or more functions desired by a service user to act on a packet desired by the service user, in a service of forwarding packets in a network.

### Solution to Problem

According to the present disclosure, a communication device is provided that includes: a communication unit that executes communication with another node; and a control unit that controls communication by the communication unit, wherein the control unit generates path information to a target node, and in the path information to a target node, at least information on communication with at least one relay node present on a path to the target node and information on a function to be executed by the relay node are described.

Moreover, according to the present disclosure, a communication device is provided that includes: a communication unit that executes communication with another node; and a control unit that controls communication by the communication unit, wherein the control unit refers to path information sent from another node and determines whether the communication device is a target node or a relay node, when the communication device is a target node, the control unit returns a response to a node that has transmitted the path information, and when the communication device is a relay node, the control unit launches a function included in the communication device based on information described in the path information.

Moreover, according to the present disclosure, a data structure is provided that used in a communication device, the communication device including a communication unit that executes communication with another node, and a control unit that controls communication by the communication unit, the data structure including, as path information between the communication device and a target node, at least information on communication with at least one relay node present on a path to the target node and information on a function to be executed by the relay node.

Moreover, according to the present disclosure, a communication method is provided that includes: executing communication with another node; and controlling the communication with another node, wherein control of the communication with another node includes generating path information to a target node, and in the path information to a target node, at least information on communication with at least one relay node present on a path to the target node and information on a function to be executed by the relay node are described.

Moreover, according to the present disclosure, a communication method is provided that includes: executing communication with another node; and controlling the communication with another node, wherein control of the communication with another node includes referring to path information sent from another node and determining whether a communication device is a target node or a relay node, and when the communication device is a target node, a response to a node that has transmitted the path information is returned, as control of the communication with another node, when the communication device is a relay node, a function included in the communication device is launched based on information described in the path information, as control of the communication with another node.

Moreover, according to the present disclosure, a computer program is provided that causes a computer to execute: executing communication with another node; and controlling the communication with another node, wherein control of the communication with another node includes generating path information to a target node, and in the path information to a target node, at least information on communication with at least one relay node present on a path to the target node and information on a function to be executed by the relay node are described.

Moreover, according to the present disclosure, a computer program is provided that causes a computer to execute: executing communication with another node; and controlling the communication with another node, wherein control of the communication with another node includes referring to path information sent from another node and determining whether a communication device is a target node or a relay node, when the communication device is a target node, a response to a node that has transmitted the path information is returned, as control of the communication with another node, and when the communication device is a relay node, a function included in the communication device is launched based on information described in the path information, as control of the communication with another node.

### Advantageous Effects of Invention

As explained above, the present disclosure provides a new and improved communication device, data structure, communication method, and computer program that enable one or more functions desired by a service user to act on a packet desired by the service user, in a service of forwarding packets in a network.

The effect above is not always limitative, and any effects illustrated in the present description or other effects that may be construed from the present description may be achieved in addition to the effect above or instead of the effect above.

### BRIEF DESCRIPTION OF DRAWINGS

FIG. 1 is an architecture example for SFC described in Non Patent Literature 1.

FIG. 2A is a diagram illustrating an example of the shape of an AFC path.

FIG. 2B is a diagram illustrating an example of the shape of an AFC path.

FIG. 2C is a diagram illustrating an example of the shape of an AFC path.

FIG. 2D is a diagram illustrating an example of the shape of an AFC path.

FIG. 3 is a diagram illustrating an example of a linear AFC path.

FIG. 4 is a diagram illustrating an example of the procedure for establishing a linear AFC path.

FIG. 5 is a diagram illustrating a format example of a message.

FIG. 6A is a diagram illustrating a format example of a packet.

FIG. 6B is a diagram illustrating a format example of a packet.

FIG. 6C is a diagram illustrating a format example of a packet.

FIG. 7A is a diagram illustrating a format example of a packet.

FIG. 7B is a diagram illustrating a format example of a message.

FIG. 8 is a diagram illustrating a data structure example of tables.

FIG. 9 is a diagram illustrating a data structure example of tables.

FIG. 10 is a diagram illustrating a data structure example of tables.

FIG. 11 is a diagram illustrating a data structure example of tables.

FIG. 12 is a flowchart illustrating an example of data transmission/reception on the linear AFC path illustrated in FIG. 3.

FIG. 13 is a flowchart illustrating the procedure of disconnecting the AFC path illustrated in FIG. 3.

FIG. 14A is a diagram illustrating a format example of a message.

FIG. 14B is a diagram illustrating a format example of a packet.

FIG. 15 is a diagram illustrating an example of an AFC path with branch and merge.

FIG. 16 is a flowchart illustrating an operation example in changing the shape of an AFC path.

FIG. 17 is a diagram illustrating a format example of a message.

FIG. 18A is a diagram illustrating a format example of a packet.

FIG. 18B is a diagram illustrating a format example of a packet.

FIG. 18C is a diagram illustrating a format example of a packet.

FIG. 19A is a diagram illustrating a format example of a packet.

FIG. 19B is a diagram illustrating a format example of a message.

FIG. 20 is a diagram illustrating a data structure example of tables.

FIG. 21 is a diagram illustrating a data structure example of tables.

FIG. 22 is a diagram illustrating a data structure example of tables.

FIG. 23 is a diagram illustrating a data structure example of tables.

FIG. 24 is a flowchart illustrating the procedure of setting a branch condition in an AFC path with branch and merge.

FIG. 25A is a diagram illustrating a format example of a message.

FIG. 25B is a diagram illustrating a format example of a packet.

FIG. 25C is a diagram illustrating a format example of a packet.

FIG. 26 is a diagram illustrating a data structure example of tables.

FIG. 27 is a diagram illustrating an example of an AFC path having a plurality of Responder nodes.

FIG. 28 is a flowchart illustrating the procedure of changing the linear AFC path illustrated in FIG. 3 to the AFC path illustrated in FIG. 27.

FIG. 29 illustrates a format example of a message.

FIG. 30A is a diagram illustrating a format example of a packet.

FIG. 30B is a diagram illustrating a format example of a packet.

FIG. 30C is a diagram illustrating a format example of a packet.

FIG. 31A is a diagram illustrating a format example of a packet.

FIG. 31B is a diagram illustrating a format example of a message.

FIG. 32 is a diagram illustrating a data structure example of tables.

FIG. 33 is a diagram illustrating a data structure example of tables.

FIG. 34 is a diagram illustrating an example of an AFC path having a plurality of Initiator nodes.

FIG. 35 is a diagram illustrating an example of the procedure of changing the linear AFC path illustrated in FIG. 34 to the AFC path having a plurality of Initiator nodes.

FIG. 36 is a diagram illustrating a format example of a message.

FIG. 37A is a diagram illustrating a format example of a packet.

FIG. 37B is a diagram illustrating a format example of a packet.

FIG. 38A is a diagram illustrating a format example of a packet.

FIG. 38B is a diagram illustrating a format example of a message.

FIG. 39 is a diagram illustrating a data structure example of a table.

FIG. 40A is a diagram illustrating an example of an AFC path.

FIG. 40B is a diagram illustrating insertion of AF-3 between AF-1 and AF-2 in the AFC path illustrated in FIG. 40A.

FIG. 41 is a diagram illustrating an example of the AF processing procedure.

FIG. 42 is a diagram illustrating a format example of a message.

FIG. 43A is a diagram illustrating a format example of a packet.

FIG. 43B is a diagram illustrating a format example of a message.

FIG. 43C is a diagram illustrating a format example of a packet.

FIG. 44A is a diagram illustrating a format example of a packet.

FIG. 44B is a diagram illustrating a format example of a message.

FIG. 45 is a diagram illustrating a data structure example of tables.

FIG. 46 is a diagram illustrating a data structure example of tables.

FIG. 47 is a diagram illustrating a data structure example of tables.

FIG. 48A is a diagram illustrating an example of an AFC path before an AF is deleted.

FIG. 48B is a diagram illustrating deletion of AF-3 from the AFC path in FIG. 48A.

FIG. 49 is a flowchart illustrating the procedure of deleting an AF from the existing AFC path.

FIG. 50A is a diagram illustrating a format example of a message.

FIG. 50B is a diagram illustrating a format example of a packet.

FIG. 50C is a diagram illustrating a format example of a packet.

FIG. 51 is a diagram illustrating a Connectionless AFC architecture without an AFC Manager.

FIG. 52 is a diagram illustrating security measures in installation of an AF.

FIG. 53 is a diagram illustrating security measures in data packet forwarding on AFC.

FIG. 54 is a diagram illustrating a structure example of an AFC data packet.

FIG. 55 is a diagram illustrating security measures in deletion of an AF.

FIG. 56 is a diagram illustrating a Connectionless AFC architecture with an AFC Manager.

FIG. 57 is a diagram illustrating security measures in installation of an AF.

FIG. 58 is a diagram illustrating security measures in deletion of an AF.

FIG. 59 is a diagram illustrating an architecture of AFC for commercial off-the-shelf (COTS) device.

FIG. 60 is a diagram illustrating a structure example of an AFC data packet.

FIG. 61 is a diagram illustrating security measures in installation of an AF.

FIG. 62 is a diagram illustrating security measures in installation of AFC.

FIG. 63 is a diagram illustrating security measures in AFC data packet forwarding.

FIG. 64 is a diagram illustrating security measures in deletion of AFC.

FIG. 65 is a diagram illustrating security measures in deletion of an AF.

FIG. 66 is a diagram illustrating a functional configuration example of a communication device 100 that may function as a node according to an embodiment of the present disclosure.

### DESCRIPTION OF EMBODIMENTS

Preferred embodiments of the present disclosure will be described in detail with reference to the accompanying drawings. In the present description and drawings, the components having substantially the same functional configuration are denoted by the same reference signs, and an overlapping description is omitted.

The description will be given in the following order.

1. Embodiment of the Present Disclosure
1.1. Architecture Example for SFC
1.2. Specific Description of AFC

2. Closing

### 1. EMBODIMENT OF THE PRESENT DISCLOSURE

[1.1. Architecture Example for SFC]

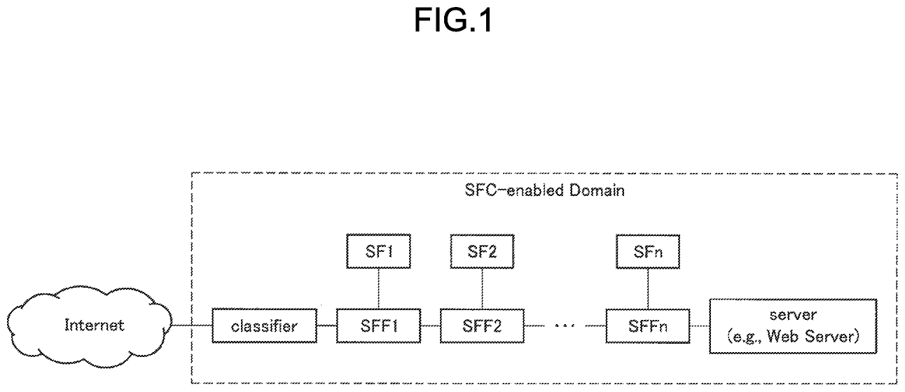

An architecture example for SFC will be first described before an embodiment of the present disclosure is described in detail. FIG. 1 illustrates an architecture example for SFC described in Non Patent Literature 1.

In the SFC architecture as illustrated in FIG. 1, a domain in which SFC is applied is called SFC-enabled Domain. In the SFC-enabled Domain, a classifier, Service Function Forwarders (SFFs), Service Functions (SFs), a server, and the like reside.

In FIG. 1, it is assumed that a Web server is accessed from the Internet. A packet entering the SFC-enabled Domain from the Internet first reaches the classifier. The classifier determines which SF is to be applied to this packet, based on the header of the packet, inserts this information as Network Service Header (NSH) into the packet, and then relays the packet. For example, it is assumed that SF1 alone is applied to this packet.

Upon receiving this packet, SFF1 finds that SF1 is to be applied to this packet based on the content of the NSH and forwards this packet to SF1. SF1 processes this packet and returns the packet to SFF1. SFF1 forwards this packet to SFF2. In this example, since SF1 alone is applied to the packet, SFF2 to SFFn merely relay the packet, and the packet finally reaches the Web server.

In SFC having such an architecture, SFs such as WAF and load balancers are prepared from the viewpoint of network operators and service providers. In other words, what packet is targeted by SFC is determined as intended by network operators and service providers.

By contrast, described below is an architecture for allowing one or more functions desired by a service user to act on a packet desired by the service user, in a service of forwarding packets in a network. In the present embodiment, such an architecture is referred to as Application Function Chaining (AFC), and the function acting in the AFC architecture is referred to as Application Function (AF).

[1.2. Specific Description of AFC]

(Supposed Environment)

It is assumed that an AF is provided by a network operator or a service provider to users. For example, a network operator releases a list to the public on the Web, the list including the specifications of an AF (function, input format, output format), the name of a node (one or more nodes) in which the AF is installed, the specifications of each node on which the AF operates, the use fee, and the like. In addition, the user may install an AF created by himself/herself in a node specified by the user. As described above, it is assumed that the user knows in advance what AF is installed in which node. A variety of functions of AFs can be contemplated. For example, when a service provider provides a service of distributing moving images from a server to clients, the functions may include conversion of the bit rate of moving images distributed and conversion of the resolution of moving images.

(Kinds of Nodes and AFC Paths)

The terms used in the present embodiment are defined below. A path established for AFC is termed AFC path. An application requesting establishment of an AFC path is termed Initiator application, and a node on which the Initiator application operates is termed Initiator node. An application that the Initiator application communicates with is termed Responder application, and a node on which the Responder application operates is termed Responder node. A node on which an AF operates is termed AF node. A path from the Initiator node to the Responder node is termed downstream direction, and the opposite direction is termed upstream direction.

It is assumed that a daemon process called AFC daemon-p operates on each of the above-noted nodes. The AFC daemon-p has a port number (which is termed well-known port) with a fixed value. The AFC daemon-p waits for a request for establishment of an AFC path on the well-known port and, upon receiving a request for establishment, initiates an AFC daemon that is a child process. The subsequent process related to the AFC path is performed by the AFC daemon. On the Initiator node or the Responder node, the Initiator application and the Responder application transmit/receive a packet through AFC daemons. At an AF node, the AFC daemon receives a data packet from another AF node and passes a data section of the packet to the AF. The AF processes the data and passes the result to the AFC daemon. The AFC daemon packetizes the data received from the AF and transmits the packet to the next AF node or the Responder node. AFs may be applied only to a packet in the downstream direction and vice versa, that is, AFs may be applied only to a packet in the upstream direction. AFs may be applied to a packet in both directions.

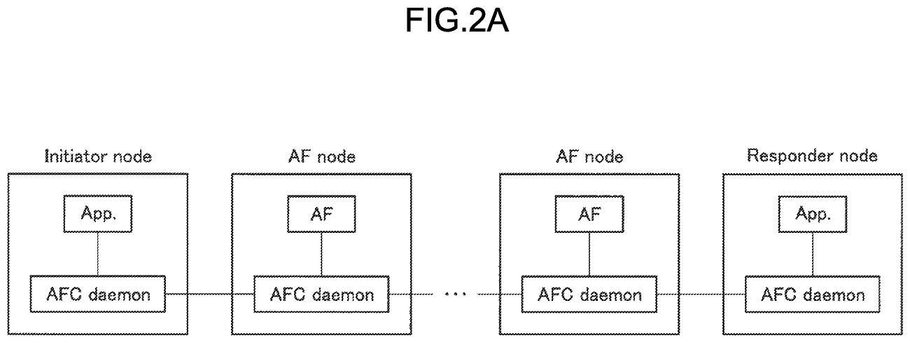

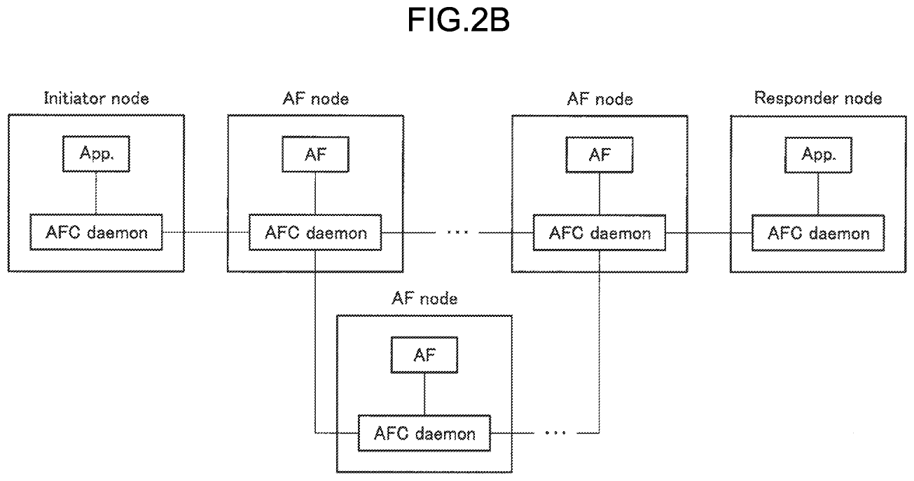

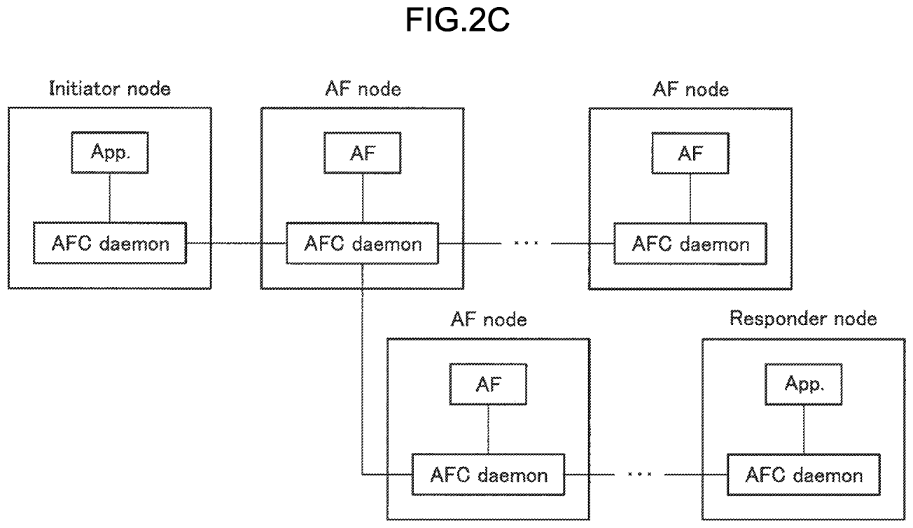

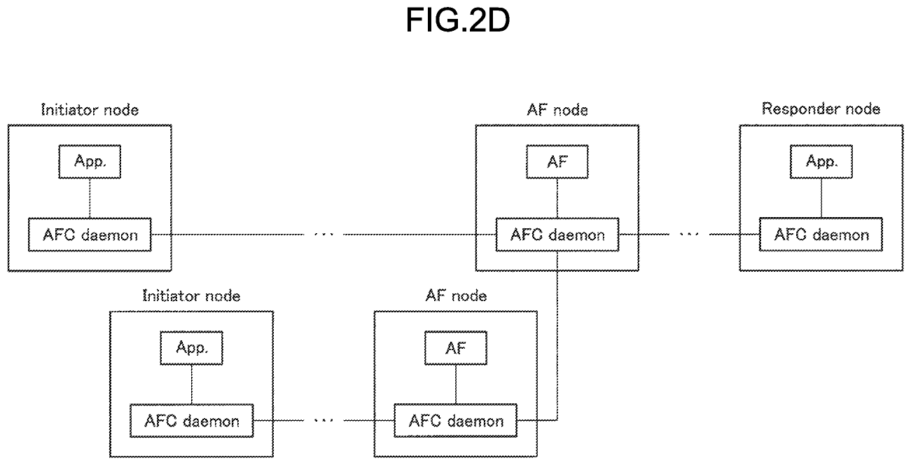

FIGS. 2A to 2D are diagrams illustrating an example of the shape of an AFC path. Four kinds illustrated in FIGS. 2A to 2D are possible as the shapes of AFC paths. In the figures, the description of AFC daemon-p is omitted. FIG. 2A illustrates a shape in which an Initiator application is linearly connected with one or more AFs and a Responder application. FIG. 2B illustrates a shape in which an AFC path branches at an AF on the way and merges at another AF. In this shape, depending on the process result by the AF, for example, whether the value output in the process result by the AF is equal to or greater than or less than a predetermined value, the AF node selects an AF subsequently applied, and ultimately, communication can be performed between a pair of Initiator application and Responder application. In this example, an AFC path branches to one AF and merges from one AF. However, there may be a plurality of AFs to branch or merge. An AFC path may branch to any AF and may merge from any AF. FIG. 2C illustrates a shape in which a plurality of Responder applications exist for one Initiator application. In this shape, an Initiator application performs multicast to a plurality of Responder applications, and an AF to be applied can be selected for each Responder application. This example illustrates two Responder applications, but there may be three or more Responder applications. The AFC path may branch to any AF. FIG. 2D illustrates a shape in which one Responder application exists for a plurality of Initiator applications. In this shape, there are a plurality of data generating sources such as sensors, an AF to be applied can be selected for each data generating source, and ultimately, data can be collected by one Responder application. This example illustrates two Initiator applications, but there may be three or more Initiator applications. The AFC path may merge from any AF. In the following example, one AF operates on one node. However, a plurality of AFs may operate on one node.

(Procedure of Establishing Linear AFC Path)

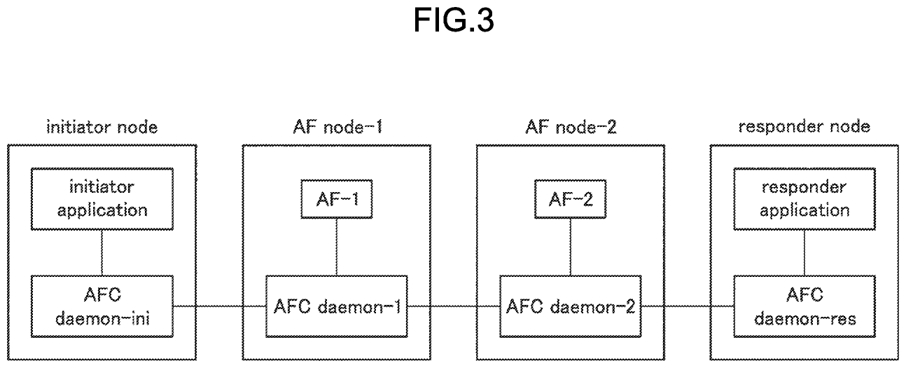

The procedure of establishing a linear AFC path is described. FIG. 3 is a diagram illustrating an example of a linear AFC path. In FIG. 3, the description of AFC daemon-p is omitted. This AFC path includes two AFs: AF-1 and AF-2 between an Initiator application and a Responder application. AF-1 and AF-2 operate on AF node-1 and AF node-2, respectively. The IP addresses of the Initiator node, AF node-1, AF node-2, and the Responder node are denoted as IP-ini, IP-1, IP-2, and IP-res, respectively. In this example, one AF operates on one node. However, a plurality of AFs may operate on one AF node.

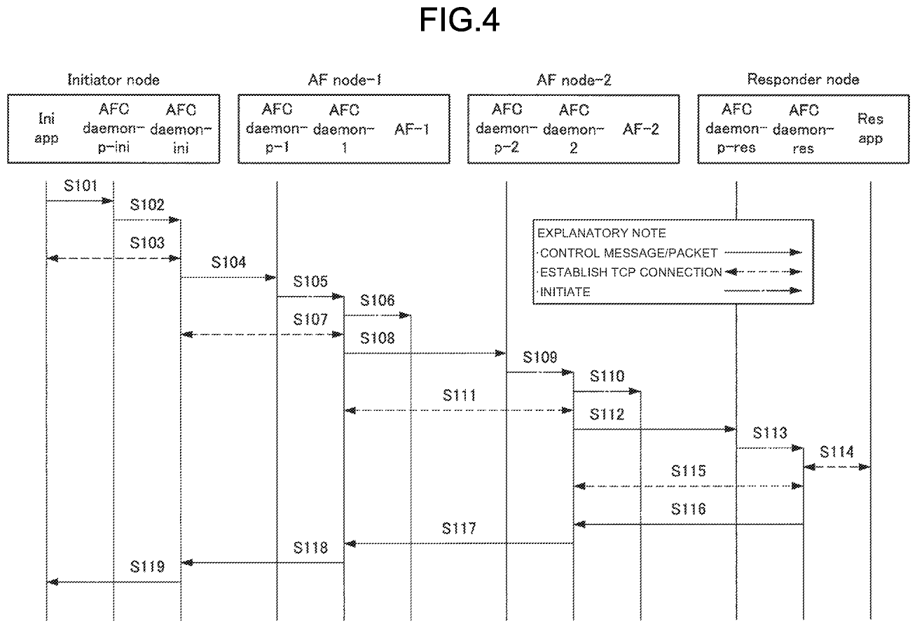

FIG. 4 is a diagram illustrating an example of the procedure of establishing a linear AFC path. First of all, an Initiator application creates a Connect Request message.

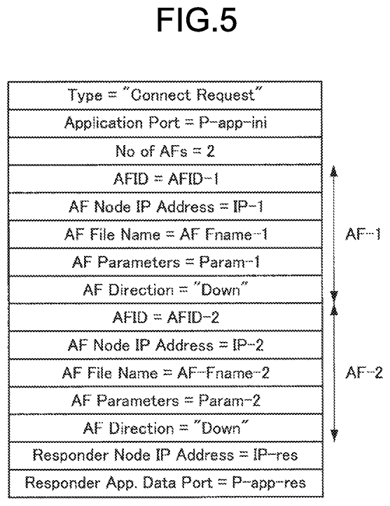

FIG. 5 is a diagram illustrating a format example of the Connect Request message generated by the Initiator application. The Type field indicates a message type. In the example in FIG. 5, “Connect Request” is set. The Application Port field indicates a port number used by the Initiator application in data communication. This port number is specified by the Initiator application. In this example, P-app-ini is set. The No of AFs field indicates the number of AFs installed in the AFC path to be established. In this example, 2 is set.

For each AF, the following five fields exist.

(1) The AFID field indicates the identifier of the AF.

(2) The AF Node IP address field indicates the IP address of the node on which the AF operates.

(3) The AF File Name field indicates the executable file name of the AF.

(4) The AF Parameters field indicates a parameter when the AF is initiated.

(5) The AF Direction field indicates a data packet flowing in which direction the AF is applied to. “Down” indicates the downstream direction, and “Up” indicates the upstream direction. “Both” indicates both directions.

In this example, the zeroth AF has an identifier AFID-1 and operates on a node having an IP address IP-1, the executable file name is AF Fname-1, the identifier of the AF is AFID-1, the parameter during initiation is Param-1, and the AF is applied to a packet in the downstream direction. In this example, the first AF has an identifier called AFID-2 and operates on a node having an IP address IP-2, the file name is AF Fname-2, the parameter during initiation of the AF is Param-2, and the AF is applied to a packet in the downstream direction.

The Responder Node IP address field indicates the IP address of the Responder node. This value is specified by the Initiator application. In this example, a value IP-res is set. The Responder Application Data Port field indicates the port number used by the Responder application for data communication. This value is specified by the Initiator application. In this example, a value P-app-res is set.

Next, the Initiator application transmits a Connect Request message to AFC daemon-p-ini (step S101). For the mentioned operation, the start-point port number is P-ctrl-app-ini, and the end-point port number is P-wk that is the well-known port number of AFC daemon-p.

Next, upon receiving the Connect Request message, AFC daemon-p-ini initiates AFC daemon-ini (step S102). The subsequent process is executed by AFC daemon-ini.

Next, the initiated AFC daemon-ini creates P-ini as a port of data communication with the Initiator application, P-ctrl-ini as a port for control communication, and P-down-ini as a port for data communication with a downstream node. Next, AFC daemon-ini establishes a TCP connection with the Initiator application (step S103). For the mentioned operation, the start-point port number is P-ini, and the end-point port number is P-app-ini.

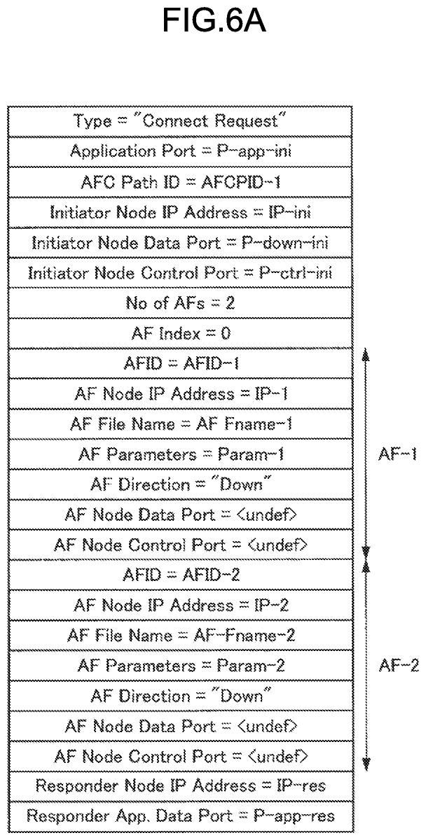

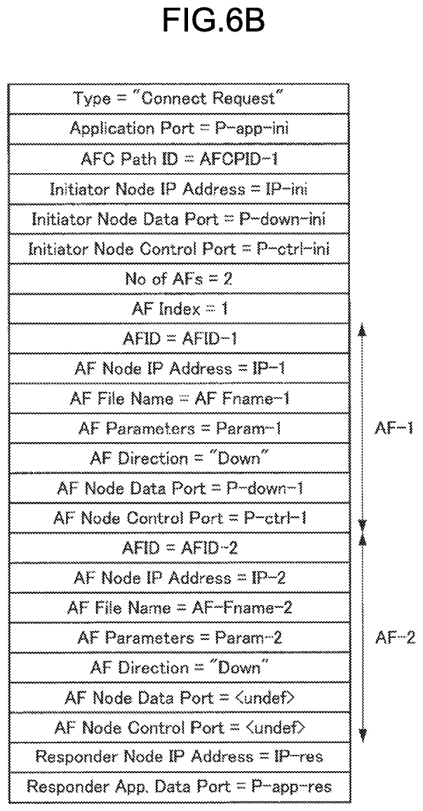

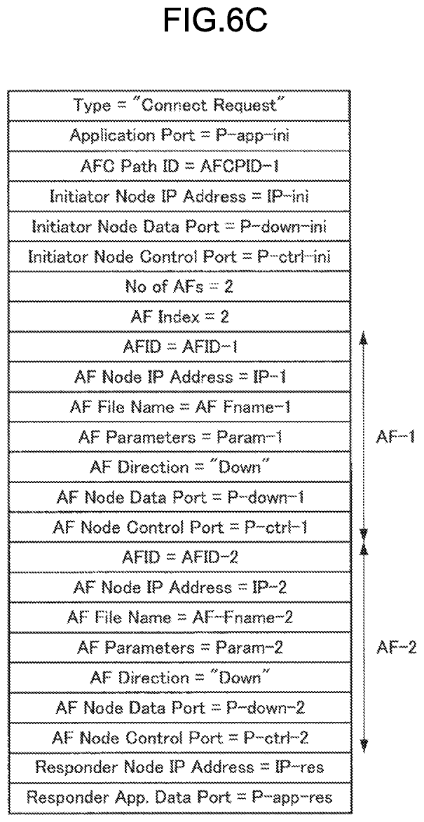

Next, AFC daemon-ini creates a Connect Request packet. FIG. 6A illustrates a format example of the Connect Request packet generated by AFC daemon-ini. The fields of the Connect Request packet are described. The Type field indicates a packet type. In this example, “Connect Request” is set. The AFC Path ID field indicates the identifier of an AFC path to be established. In this example, AFCPID-1 is set. The Initiator Node IP Address field indicates the IP address of the Initiator node. In this example, IP-ini is set. The Initiator Node Data Port field indicates a port for downstream data communication of the Initiator node. In this example, P-down-ini is set. The Initiator Node Control Port field indicates a port for control communication of the Initiator node. In this example, P-ctrl-ini is set. The No of AFs field indicates the number of AFs to be initiated. In this example, 2 is set. The AF Index field indicates what order of AF is the process target at present. The value in this field is 0 as the origin. For each AF, seven fields exist: the AFID field, the AF Node IP Address field, the AF File Name field, the AF Parameters field, the AF Direction field, the AF Node Data Port field, and the AF Node Control Port field.

The roles and the values of the first five fields are similar to the corresponding fields of the Connect Request message illustrated in FIG. 5. The AF Node Data Port field indicates the port number when the AF node performs data communication with a downstream node. The AF Node Control Port field indicates a port for control communication of the AF node. At this point of time, for two AF nodes, the values in the AF Node Data Port field and the AF Node Control Port field are not yet determined. The Responder Node IP address field indicates the IP address of the Responder node. In this example, IP-res is set. The Responder Application Data Port field indicates the port number used by the Responder Application for data communication. In this example, P-app-res is set.

Next, AFC daemon-ini transmits the Connect Request packet to AFC daemon-p-1 at the node (AF node-1) indicated by the zeroth AF Node IP Address field of the Connect Request packet (step S104). For the mentioned operation, the end-point port number is P-wk that is the well-known port number of AFC daemon-p.

Upon receiving the Connect Request packet, AFC daemon-p-1 initiates AFC daemon-1 (step S105). The subsequent process is executed by AFC daemon-1. As the value (0) in the AF Index field of the Connect Request packet is smaller than the value (2) in the No of AFs field, AFC daemon-1 recognizes that the process for the zeroth AF is to be performed. AFC daemon-1 creates P-up-1 as a port for upstream data communication, P-down-1 as a port for downstream data communication, and P-ctrl-1 as a port for control communication.

The initiated AFC daemon-1 executes AF Fname-1 that is an executable file indicated by the AF File Name field, using Param-1 indicated by the AF Parameters field of the Connect Request packet as a parameter, and initiates AF-1 (step S106). For the mentioned operation, the standard input and the standard output of AF-1 are connected to fd-afin-1 and fd-afout-1 that are sockets of AFC daemon-1.

Subsequently, AFC daemon-1 establishes a TCP connection between P-up-1 that is the port for upstream data communication and P-down-ini that is the port for downstream data communication of AFC daemon-ini (step S107). Subsequently, AFC daemon-1 creates a Connect Request packet. FIG. 6B illustrates a format example of the Connect Request packet generated by AFC daemon-1. In this Connect Request packet, of the fields related to the zeroth AF in FIG. 6A, P-down-1 is set in the AF Node Data Port field, and P-ctrl-1 is set in the AF Node Control Port field. The value in the AF Index field is incremented, and the value changes from 0 to 1. Since the value in the AF Index field is smaller than the value in the No of AFs field, AFC daemon-1 recognizes that the next stage of the AFC path is also an AF.

Next, AFC daemon-1 transmits the Connect Request packet to AFC daemon-p-2 at the node (AF node-2) indicated by the first AF node IP Address field (step S108).

Upon receiving the Connect Request packet, AFC daemon-p-2 initiates AFC daemon-2 (step S109). The subsequent process is executed by AFC daemon-2. As the value (1) in the AF Index field of the Connect Request packet is smaller than the value (2) in the No of AFs field, AFC daemon-2 recognizes that the process related to the first AF is to be performed. AFC daemon-2 creates P-up-2 as a port for upstream data communication, P-down-2 as a port for downstream data communication, and P-ctrl-2 as a port for control communication.

AFC daemon-2 executes AF Fname-2 that is the executable file indicated by the AF File Name field, using Param-2 indicated by the AF Parameters field of the Connect Request packet as a parameter, and initiates AF-2 (step S110). For the mentioned operation, the standard input and the standard output of AF-2 are connected to fd-afin-2 and fd-afout-2 that are sockets of AFC daemon-2.

Subsequently, AFC daemon-2 establishes a TCP connection between P-up-2 that is the port for upstream data communication and P-down-1 that is the port for downstream data communication of AFC daemon-1 (step S111).

Subsequently, AFC daemon-2 creates a Connect Request packet. FIG. 6C illustrates a format example of the Connect Request packet created by AFC daemon-2. In this Connect Request packet, of the fields related to the first AF in FIG. 6B, P-down-2 is set in the AF Node Data Port field, and P-ctrl-2 is set in the AF Node Control Port field. The value in the AF Index field is incremented, and the value changes from 1 to 2. As a result, the value in the No of AFs field and the value in the AF Index field are equal, so that AFC daemon-2 recognizes that the next stage is the Responder application.

Next, AFC daemon-2 transmits the Connect Request packet to P-wk that is the well-known port of AFC daemon-p-res (step S112).

Upon receiving the Connect Request packet, AFC daemon-p-res initiates AFC daemon-res (step S113). The subsequent process is executed by AFC daemon-res. AFC daemon-res recognizes that its node is the Responder node, from the value in the Responder Node IP Address field of the Connect Request packet. AFC daemon-res creates P-up-2 as a port for upstream data communication, P-ctrl-2 as a port for control communication, and P-res as a port for communication with the Responder application.

Subsequently, AFC daemon-res establishes a TCP connection with the Responder application (step S114). For the mentioned operation, the start-point port number is P-res, and the end-point port number is P-app-res.

Subsequently, AFC daemon-res establishes a TCP connection between P-up-res that is the port for upstream data communication and P-down-2 that is the port for downstream data communication of AFC daemon-2 (step S115).

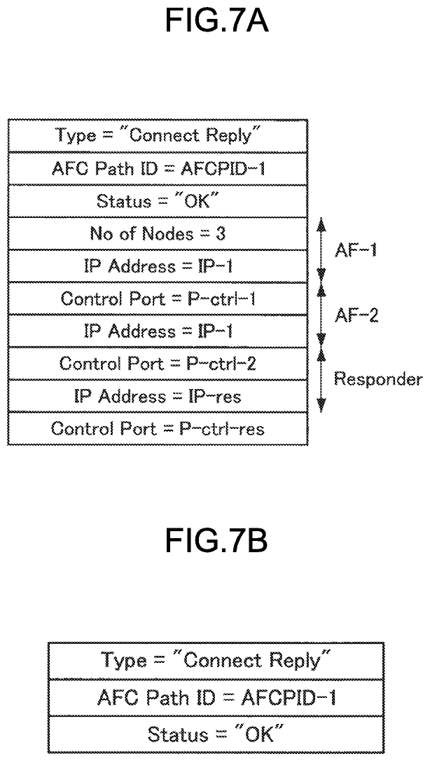

Subsequently, AFC daemon-res creates a Connect Reply packet. FIG. 7A illustrates a format example of the Connect Reply packet created by AFC daemon-res. The fields of the Connect Reply packet are described. The Type field indicates a packet type. In this example, “Connect Reply” is set. The AFC Path ID field indicates the identifier of the established AFC path. In this example, AFCPID-1 is set. The Status field indicates the process result. In this example, “OK” indicating success is set. The No of Nodes field indicates the total of the number of AF nodes and Responder node included in the established AFC path. In this example, 3 is set. For each node, the following two fields exist. The IP address field indicates the IP address of the node. The Control Port field indicates the port for control communication of the node. In this example, IP-1 and P-ctrl-1 that are the IP address and the port for control communication of AF node-1, IP-2 and P-ctrl-2 that are the IP address and the port for control communication of AF node-2, and IP-res and P-ctrl-res that are the IP address and the port for control communication of the Responder node are set.

Next, AFC daemon-res transmits the Connect Reply packet to AFC daemon-2 (step S116). For the mentioned operation, the start-point port number is P-ctrl-res, and the end-point port number is P-ctrl-2.

Upon receiving the Connect Reply packet, AFC daemon-2 forwards this to AFC daemon-1 (step S117). For the mentioned operation, the start-point port number is P-ctrl-2, and the end-point port number is P-ctrl-1.

Upon receiving the Connect Reply packet, AFC daemon-1 forward this to AFC daemon-ini (step S118). For the mentioned operation, the start-point port number is P-ctrl-1, and the end-point port number is P-ctrl-ini.

Upon receiving the Connect Reply packet, AFC daemon-ini creates a Connect Reply message. FIG. 7B illustrates a format example of the Connect Reply message generated by AFC daemon-ini. The fields are described. The Type field indicates a message type. In this example, “Connect Reply” is set. The AFC Path ID field indicates the identifier of the established AFC path. In this example, AFCPID-1 is set. The Status field indicates the process result. In this example, “OK” indicating success is set.

Next, AFC daemon-ini transmits the Connect Reply message to the Initiator application (step S119). For the mentioned operation, the start-point port number is P-ctrl-ini, and the end-point port number is P-ctrl-app-ini.

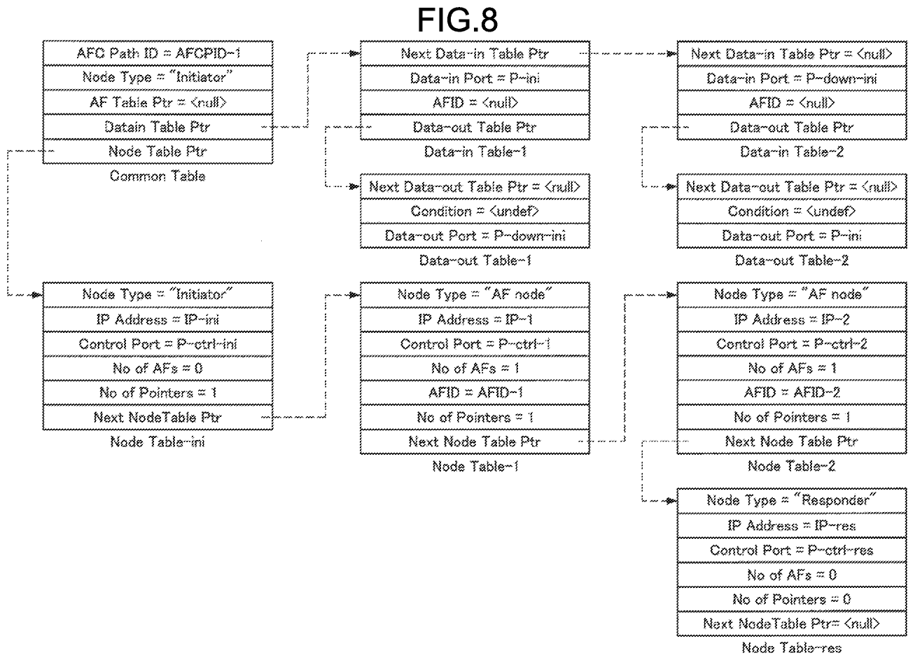

As a result of the process above, AFC daemon-ini holds the tables illustrated in FIG. 8. The contents of the tables will be described below.

Common Table is a table of pointers to other tables. The AFC Path ID field indicates the identifier of the AFC path. In this example, AFCPID-1 is held. The Node Type field indicates the kind of its own node. In this example, “Initiator” is held. The AF Table Pointer field holds a pointer to AF Table. In this example, “null” is held. The Data-in Table Pointer field holds a pointer to Data-in Table. In this example, a pointer to Data-in Table-1 is held. The Node Table Pointer field holds a pointer to Node Table. In this example, a pointer to Node Table-ini is held.

Data-in Table holds information on data packet reception on the AFC path. When a plurality of Data-in Tables exist, Data-in Tables are in the form of a list structure. The Next Data-in Table Pointer field is a field for configuring a list. The Data-in Port field indicates a port number receiving a data packet. The AFID field indicates the identifier of an AF applied to a data packet. The Data-out Table Pointer field is a pointer to Data-out Table that is a table for managing the transmission destination of a data packet. In this example, the Initiator node receives a data packet from the Initiator application or AF node-1 and therefore has two Data-in Tables to make a list. Data-in Table-1 is related to a data packet received from the Initiator application. The value in the Data-in Port field is P-app-ini. Since the AF does not operate on the Initiator node, the value in the AFID field is “null”. Data-in Table-2 is related to a data packet received from AF node-1. The value in the Data-in Port field is P-down-ini. As described above, the value in the AFID field is “null”.

Data-out Table holds information on a forwarding destination of a data packet. When the forwarding destination of a data packet varies depending on the process result by the AF, a plurality of Data-out Tables exist for one Data-in Table. Data-out Tables are also in the form of a list structure. The Next Data-out Table Pointer field is a field for configuring a list. The Condition field indicates that this Data-out Table is to be used when the process result of the AF satisfies the condition indicated by this field. Data-out Port indicates the port number to which a data packet is forwarded. In this example, Condition is not set in Data-out Table-1, and the forwarding destination port of a data packet is P-down-ini. Condition is not set in Data-out Table-2 either, and the forwarding destination port of a data packet is P-app-ini.

Node Table is created one for each of all the nodes included in the AFC path, and the Next Node Table Pointer field indicates the relation between nodes. The Node Type field holds the type of node (any one of “Initiator”, “AF node”, and “Responder”). The IP Address field holds the IP address of the node. The Control Port field holds a port number for control communication. The No of AFs field holds how many AFs operate on the corresponding node. The No of Pointers field holds how many nodes exist downstream of the corresponding node.

Node Table-ini is a Node Table related to the Initiator node. In this example, it is indicated that the IP address is IP-ini, the port number for control communication is P-ctrl-ini, the number of AFs is 0, and there is one downstream node.

Node Table-1 is a Node Table related to AF node-1. In this example, it is indicated that the IP address is IP-1, the port number for control communication is P-ctrl-1, the number of AFs is 1, the identifier of the AF is AFID-1, and there is one downstream node.

Node Table-2 is a Node Table related to AF node-2. In this example, it is indicated that the IP address is IP-2, the port number for control communication is P-ctrl-2, the number of AFs is 1, the identifier of the AF is AFID-2, and there is one downstream node.

Node Table-res is a Node Table related to the Responder node. In this example, it is indicated that the IP address is IP-res, the port number for control communication is IP-ctrl-res, the number of AFs is 0, and no downstream node exists.

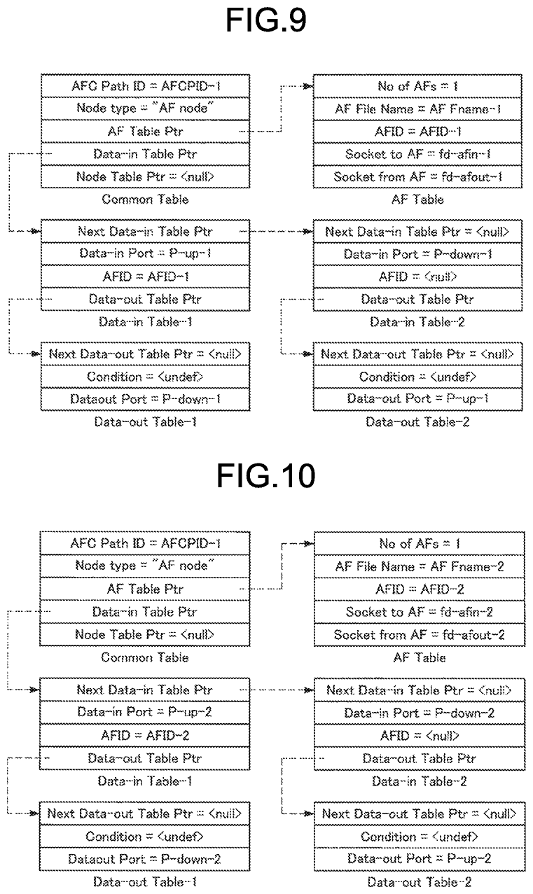

FIG. 9 illustrates the tables held by AFC daemon-1. The roles of Common Table, Data-in Table, and Data-out Table are as described above. AF Table holds information on the AF operating on the corresponding node. The No of AFs field holds how many AFs are operating on the corresponding node. In this example, the number is 1. In each AF, the following four fields exist.

The AF File Name field holds the executable file name of the AF. In this example, AF Fname-1 is set. The AFID field holes the identifier of the AF. In this example, AFID-1 is set. The Socket to AF field holds a socket in transmitting data to an AF. In this example, fd-afin-1 is set. The Socket from AF field holds a socket in receiving data from an AF. In this example, fd-afout-1 is set.

FIG. 10 illustrates the tables held by AFC daemon-2. The contents are similar to those of the tables held by AFC daemon-1 illustrated in FIG. 9, and the held values vary with fields.

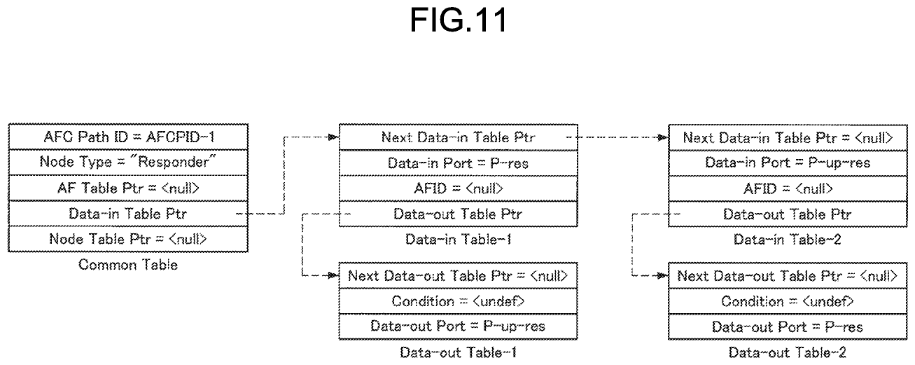

FIG. 11 illustrates the tables held by the Responder node. The contents are similar to those of Common Table, Data-in Table, and Data-out Table illustrated in FIG. 8, and the held values vary with fields.

(Transmission/Reception of Data)

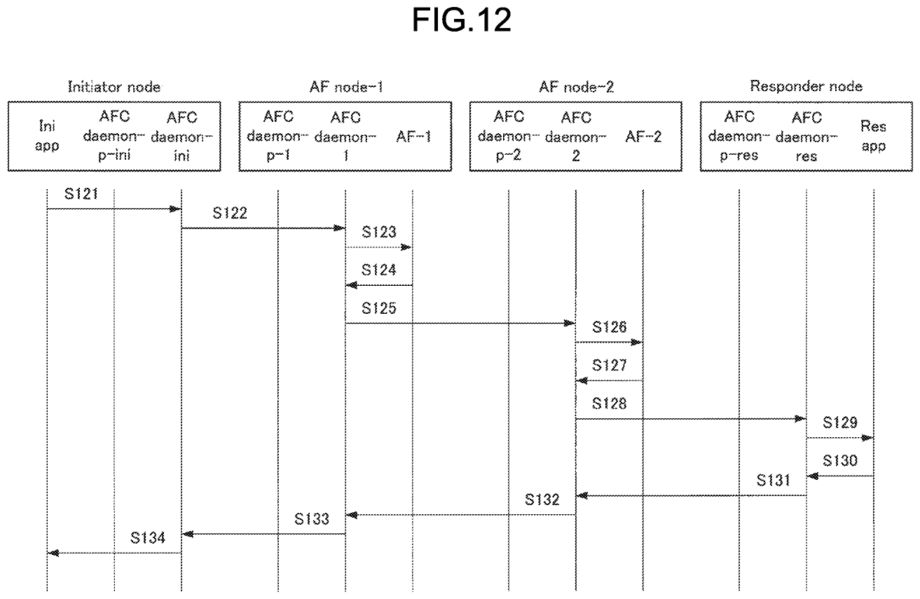

An example of data transmission/reception on the linear AFC path illustrated in FIG. 3 will now be described. FIG. 12 is a flowchart illustrating an example of data transmission/reception on the linear AFC path illustrated in FIG. 3. In this example, the Initiator application transmits data to the Responder application, and the Responder application returns a response to the Initiator application.

First, the Initiator application transmits data to AFC daemon-ini (step S121). For the mentioned operation, the start-point port number is P-app-ini, and the end-point port number is P-ini.

Upon receiving data from the Initiator application, AFC daemon-ini finds Data-in Table-1 in which the value in the Data-in Port field is P-ini, from among Data-in Tables illustrated in FIG. 8. The Data-out Table Pointer field of Data-in Table-1 points to Data-out Table-1. Since the value in the Data-out Port field of Data-out Table-1 is P-down-ini, AFC daemon-ini transmits data from P-down-ini (step S122). AFC daemon-1 receives data from P-up-1.

AFC daemon-1 finds Data-in Table-1 in which the value in Data-in Port is P-up-1, from among Data-in Tables illustrated in FIG. 9. Since the value in the AFID field of Data-in Table-1 is AFID-1, AFC daemon-1 refers to AF Table illustrated in FIG. 9. Since the value in the Socket to AF field of AF Table is fd-afin-1, AFC daemon-1 transmits the received data from fd-afin-1 (step S123). AF-1 receives data from the standard input and processes this data.

AF-1 outputs the processed data from the standard output (step S124). AFC daemon-1 receives data from fd-afout-1.

The Data-out Table Pointer field of Data-in Table-1 illustrated in FIG. 9 points to Data-out Table-1. Since the value in the Condition field of Data-out Table-1 is not yet set, Data-out Table-1 is used as information on the transmission destination of data, irrespective of the process result of AF-1. Since the value in the Data-out Port field of Data-out Table-1 is P-down-1, AFC daemon-1 transmits data from P-down-1 (step S125). AFC daemon-2 receives data from P-up-2.

AFC daemon-2 finds Data-in Table-1 in which the value in the Data-in Port field is P-up-2, from among Data-in Tables illustrated in FIG. 10. Since the value in the AFID field of Data-in Table is AFID-2, AFC daemon-2 refers to AF Table illustrated in FIG. 10. Since the value in the Socket to AF field of AF Table is fd-afin-2, AFC daemon-2 transmits the received data to fd-afin-2 (step S126). AF-2 receives data from the standard input and processes this data.

AF-2 outputs the processed data from the standard output (step S127). AFC daemon-2 receives data from fd-afout-2.

The Data-out Table Pointer field of Data-in Table-1 illustrated in FIG. 10 points to Data-out Table-1. Since the value in the Condition field of Data-out Table-1 is not yet set, Data-out Table-1 is used as information on the transmission destination of data, irrespective of the output result of AF-2. Since the value in the Data-out Port field of Data-out Table-1 is P-down-2, AFC daemon-2 transmits data from P-down-2 (step S128). AFC daemon-res receives data from P-up-res.

AFC daemon-res finds Data-in Table-2 in which the value in the Data-in Port is P-up-res, from among Data-in Tables illustrated in FIG. 11. Since the value in the AFID field of Data-in Table-2 is “null”, AFC daemon-res finds that no AF is applied. The Data-out Table Pointer field points to Data-out Table-2. Since the value in the Data-out Port field of Data-out Table-2 is P-res, AFC daemon-res transmits data to P-res (step S129). The Responder application receives data from P-app-res.

The Responder application transmits response data to the received data from P-app-res (step S130). AFC daemon-res receives data from P-res.

AFC daemon-res finds Data-in Table-1 in which the value in the Data-in Port field is P-res, from among Data-in Tables illustrated in FIG. 11. Since the value in the AFID field of Data-in Table-1 is “null”, AFC daemon-res finds that no AF is applied. The Data-out Table Pointer field points to Data-out Table-1. Since the value in the Data-out Port field of Data-out Table-1 is P-up-res, AFC daemon-res transmits data from P-up-res (step S131). AFC daemon-2 receives data from P-down-2.

AFC daemon-2 finds Data-in Table-2 in which the value in the Data-in Port field is P-down-2, from among Data-in Tables illustrated in FIG. 10. Since the value in the AFID field of Data-in Table-2 is “null”, AFC daemon-2 finds that no AF is applied. The Data-out Table Pointer field points to Data-out Table-2. Since the value in the Data-out Port field of Data-out Table-2 is P-up-2, AFC daemon-2 transmits data from P-up-2 (step S132). AFC daemon-1 receives data from P-down-1.

AFC daemon-1 finds Data-in Table-2 in which the value in the Data-in Port field is P-down-1, from among Data-in Tables illustrated in FIG. 9. Since the value in the AFID field of Data-in Table-2 is “null”, AFC daemon-1 finds that no AF is applied. The Data-out Table Pointer field points to Data-out Table-2. Since the value in the Data-out Port field of Data-out Table-2 is P-up-1, AFC daemon-1 transmits data from P-up-1 (step S133). AFC daemon-ini receives data from P-down-ini.

AFC daemon-ini finds Data-in Table-2 in which the value in the Data-in Port field is P-down-ini, from among Data-in Tables illustrated in FIG. 8. Since the value in the AFID field of Data-in Table-2 is “null”, AFC daemon-ini finds that no AF is applied. The Data-out Table Pointer field points to Data-out Table-2. Since the value in the Data-out Port field of Data-out Table-2 is P-ini, AFC daemon-ini transmits data from P-ini (step S134). The Initiator application receives data from P-app-ini.

(AFC Path Disconnection Procedure)

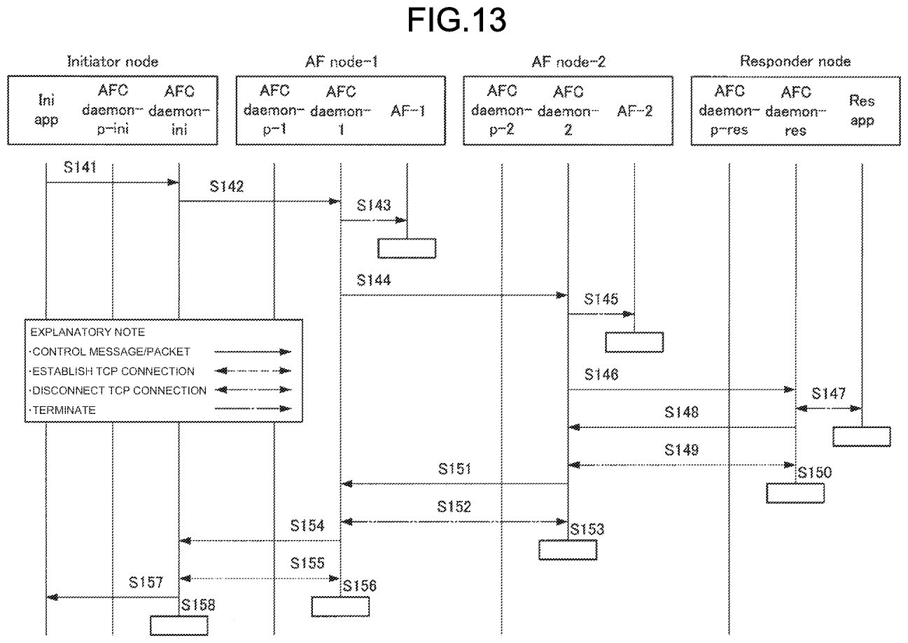

The procedure of disconnecting the AFC path illustrated in FIG. 3 will now be described. FIG. 13 is a flowchart illustrating the procedure of disconnecting the AFC path illustrated in FIG. 3.

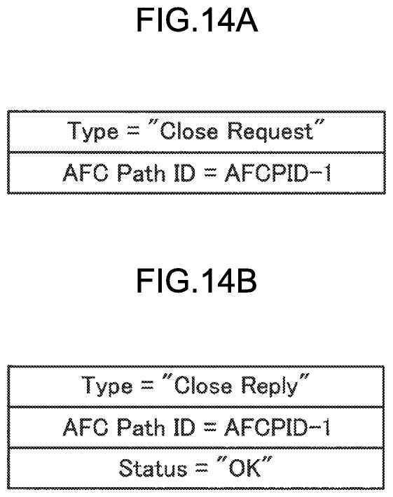

The Initiator application transmits a Close Request message to AFC daemon-ini (step S141). FIG. 14A is a format example of the Close Request message transmitted by the Initiator application. In the Type field, “Close Request” indicating a message type is set. In the AFC Path ID field, AFCPID-1 that is the identifier of the target AFC path is set.

Upon receiving the Close Request message, AFC daemon-ini creates a Close Request packet in the same format as this and transmits the created packet to AFC daemon-1 (step S142).

Upon receiving the Close Request packet, AFC daemon-1 terminates AF-1 (step S143).

AFC daemon-1 transmits the Close Request packet to AFC daemon-2 (step S144).

Upon receiving the Close Request packet, AFC daemon-2 terminates AF-2 (step S145).

Subsequently, AFC daemon-2 transmits the Close Request packet to AFC daemon-res (step S146).

Upon receiving the Close Request packet, AFC daemon-res disconnects the TCP connection with the Responder application (step S147).

AFC daemon-res creates and transmits a Close Reply packet to AFC daemon-2 (step S148). FIG. 14B illustrates a format example of the Close Reply packet transmitted by AFC daemon-res. In the Type field, “Close Reply” indicating a packet type is set. In the AFC Path ID field, AFCPID-1 that is the identifier of the target AFC path is set. In the Status field, “OK” indicating success of the process is set.

Subsequently, AFC daemon-res disconnects the TCP connection with AFC daemon-2 (step S149).

Subsequently, AFC daemon-res terminates execution (step S150).

AFC daemon-2 transmits the Close Reply packet to AFC daemon-1 (step S151).

Subsequently, AFC daemon-2 disconnects the TCP connection with AFC daemon-1 (step S152).

Subsequently, AFC daemon-2 terminates execution (step S153).

AFC daemon-1 transmits the Reply packet to AFC daemon-ini (step S154).

Subsequently, AFC daemon-1 disconnects the TCP connection with AFC daemon-ini (step S155).

Subsequently, AFC daemon-1 terminates execution (step S156).

AFC daemon-ini creates a Close Reply message in the same format as the Close Request packet and transmits the created message to the Initiator application (step S157).

Subsequently, AFC daemon-ini disconnects the TCP connection with the Initiator application (step S158).

Subsequently, AFC daemon-ini terminates execution (step S159).

(Process of Changing from Linear AFC Path to AFC Path Including Branch and Merge)

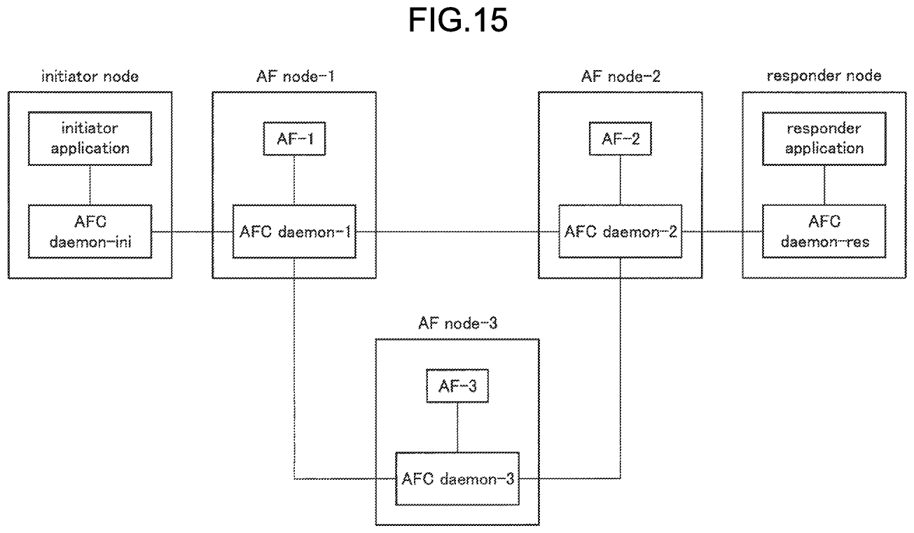

The procedure in changing the linear AFC path illustrated in FIG. 3 to the shape including branch and merge illustrated in FIG. 15 will now be described. FIG. 15 illustrates an AFC path with a branch from AF node-1 to AF node-2 and AF node-3 and a merge at AF node-2 from AF node-1 and AF node-3.

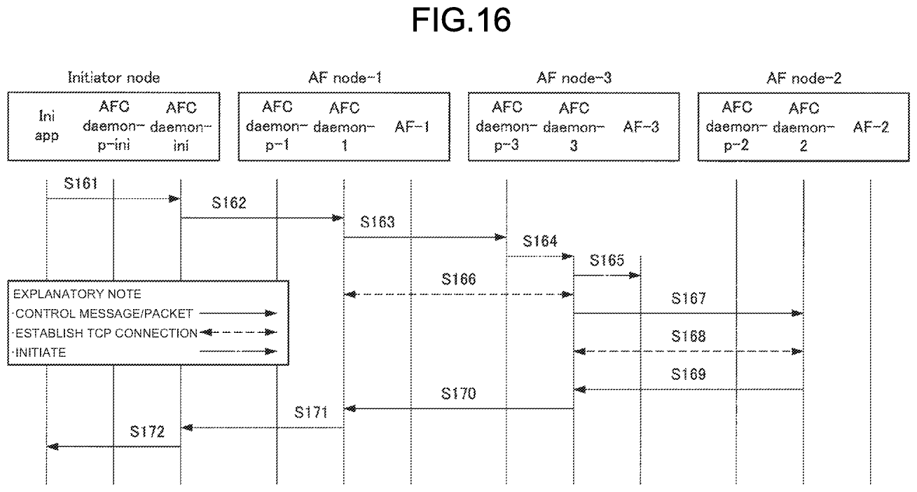

FIG. 16 is a flowchart illustrating an operation example in changing the shape of an AFC path. In FIG. 16, the description of AFC daemon-p is omitted. In this example, the AFC path branches at AF-1, AF-3 operating on AF node-3 is added to a new AFC path, and two AFC paths merge at AF-2 operating on AF node-2. It is assumed that the IP address of AF node-3 is IP-3.

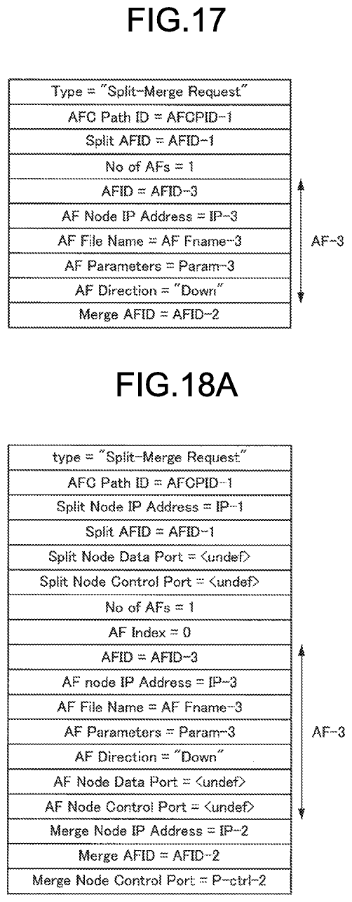

The Initiator application creates a Split-Merge Request message. FIG. 17 is a format example of the Split-Merge Request message created by the Initiator application. The fields of the Split-Merge Request message are described. The Type field indicates a message type. In this example, “Split-Merge Request” is set. The AFC Path ID field indicates the identifier of the target AFC path. In this example, AFCPID-1 is set. The Split AFID field indicates the identifier of an AF serving as a branch point of the AFC path. In this example, AFID-1 is set. The No of AFs field indicates the number of AFs installed on a new AFC path after branching. In this example, 1 is set. The following five fields exist for each AF to be newly installed.

The AFID field indicates the identifier of the AF. In this example, AFID-3 is set. The AF Node IP Address field indicates the IP address of the AF node at which an AF is newly installed. In this example, IP-3 is set. The AF File Name field indicates the executable file name of the AF to be newly installed. In this example, AF Fname-3 is set. The AF Parameters field indicates a parameter in initiating the AF. In this example, Param-3 is set. The AF Direction field indicates a data packet flowing in which direction the AF is applied to. In this example, “Down” indicating the downstream direction is set. The Merge AFID field indicates the identifier of the AF at which two split AFC paths merge. In this example, AFID-2 is set.

Next, the Initiator application transmits a Split-Merge Request message to AFC daemon-ini (step S161).

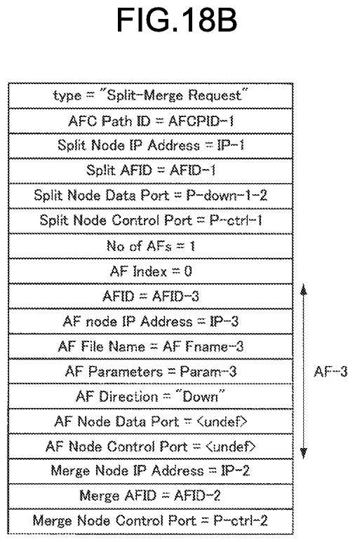

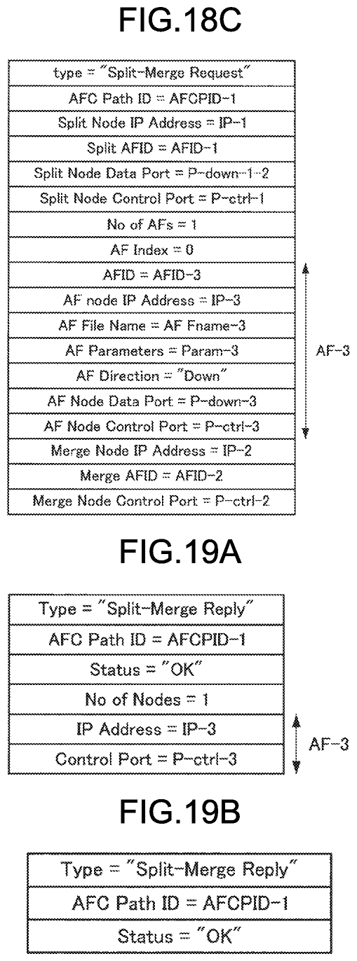

Upon receiving the Split-Merge Request message, AFC daemon-ini creates a Split-Merge Request packet. FIG. 18A illustrates a format example of the Split-Merge Request packet generated by AFC daemon-ini. The fields will be described below. The Type field indicates a packet type. In this example, “Split-Merge Request” is set. The AFC Path ID field indicates the identifier of the target AFC path. In this example, AFCPID-1 is set. The Split Node IP Address field indicates the IP address of the AF node serving as a branch point. In this example, IP-1 is set. The Split AFID field indicates the identifier of the AF serving as a branch point. In this example, AFID-1 is set. The Split Node Data Port field indicates a port for data communication used by the AFC path to be newly established. In this example, the value in this field is not yet determined. Split Node Control Port indicates a port number for control communication at the AF node serving as a branch point. In this example, the value in this field is not yet determined. The No of AFs field indicates how many AFs are installed on a new AFC path after branching. In this example, 1 is set. The AF Index field indicates what order (0 origin) of AF is the process target at present.

For each AF to be newly installed, seven fields exist: the AFID field, the AF Node IP Address field, the AF File Name field, the AF Parameters field, the AF Direction field, AF Nnode Data Port, and AF Node Control Port.

The roles and the values of the first five fields are similar to those of the Split-Merge Request message illustrated in FIG. 17. The AF Node Data Port field indicates a port for data communication of the AF node. The AF Node Control Port field indicates a port for control communication of the AF node. In this example, the values in the AF Node Data Port field and the AF Node Control Port field are not yet determined.

The Merge Node IP Address field indicates the IP address of the AF node at which two split AFC paths merge. In this example, IP-2 is set. The Merge AFID field indicates the identifier of the AF in which two split AFC paths merge. In this example, AFID-2 is set. In Control Port, P-ctrl-2 that is the port number for control communication of AF node-2 is set.

Next, AFC daemon-ini transmits the Split-Merge Request packet to AFC daemon-1 (step S162).

Upon receiving the Split-Merge Request packet, AFC daemon-1 finds that its node is a branch node, from the value in the Split AF node IP Address field. Then, P-down-1-2 is created as a new port for data communication for branching.

Next, AFC daemon-1 transmits a Split-Merge Request packet to AFC daemon-p-3 on AF node-3 as a branch destination (step S163). FIG. 18B is a diagram illustrating the Split-Merge Request packet transmitted by AFC daemon-1. In the Split-Merge Request packet illustrated in FIG. 18B, P-down-1-2 and P-ctrl-1 are set in the Split Node Data Port field and the Split Node Control Port field, respectively, in comparison to the Split-Merge Request packet illustrated in FIG. 18A.

Upon receiving the Split-Merge Request packet, AFC daemon-p-3 initiates AFC daemon-3 (step S164). The subsequent process is executed by AFC daemon-3.

AFC daemon-3 recognizes that its node is an AF node, from the value (0) in the AF Index field of the Split-Merge Request packet and the value (IP-3) in the zeroth AF Node IP Address field. AFC daemon-3 executes AF Fname-3 indicated by the AF File Name field, using Param-3 indicated by the AF Parameters field of the Split-Merge Request packet as a parameter (step S165). For the mentioned operation, the standard input and the standard output of AF-3 are connected to fd-afin-3 and fd-afout-3 that are the sockets of AFC daemon-3.

AFC daemon-3 creates P-up-3 as a port for upstream data communication and P-down-3 as a port for downstream data communication. Next, AFC daemon-3 establishes a TCP connection between P-up-3 that is the port for upstream data communication and P-down-1-2 that is the port for downstream data communication of AFC daemon-1 (step S166).

AFC daemon-3 increments the value in the AF Index field of the Split-Merge Request packet. As a result, the value in this field changes to 1, which is equal to the value in the No of AFs field. AFC daemon-3 therefore recognizes that there is no further AF newly added. AFC daemon-3 then transmits a Split-Merge Request packet to the IP address (IP-2) indicated by the Merge Node IP Address field of the Split-Merge Request packet and the port number (P-ctrl-2) indicated by the Merge Node Control Port field (step S167). FIG. 18C is a diagram illustrating an example of the Split-Merge Request packet transmitted by AFC daemon-3. In the Split-Merge Request message illustrated in FIG. 18C, P-down-3 and P-ctrl-3 are set in the AF Node Data Port field and the AF Node Control Port field, respectively, in comparison to the Split-Merge Request packet illustrated in FIG. 18B.

Upon receiving the Split-Merge Request packet, AFC daemon-2 recognizes that its node is a merge node, from the value in the Merge Node IP Address field. P-up-2-2 is then newly created as a port for upstream data communication, and a TCP connection is established between this P-up-2-2 and P-down-3 that is the port for downstream data communication of AFC daemon-3 (step S168).

AFC daemon-2 creates a Split-Merge Reply packet. FIG. 19A is a diagram illustrating an example of the Split-Merge Reply packet created by AFC daemon-2. The Type field indicates a packet type. In this example, “Split-Merge Reply” is set. The AFC Path ID field indicates the identifier of the target AFC path. In this example, AFCPID-1 is set. The Status field indicates the process result. In this example, “OK” indicating success is set. The No of Nodes field indicates the number of nodes newly added in this process. In this example, 1 is set. For each newly added node, the following two fields exist. The IP Address field indicates the IP address of the newly added node. In this example, IP-3 is set. The Control Port field indicates the port number for control message of the newly added node. In this example, P-ctrl-3 is set.

Next, AFC daemon-3 transmits the created Split-Merge Reply packet to AFC daemon-2 (step S169).

Upon receiving the Split-Merge Reply packet, AFC daemon-2 forwards this Split-Merge Reply packet to AFC daemon-1 (step S170).

Upon receiving the Split-Merge Reply packet, AFC daemon-1 forwards the Split-Merge Reply packet to AFC daemon-ini (step S171).

AFC daemon-ini creates a Split-Merge Reply message. FIG. 19B is a diagram illustrating an example of the Split-Merge Reply message created by AFC daemon-ini. The fields of the Split-Merge Reply message are described. The Type field indicates a message type. In this example, “Split-Merge Reply” is set. The AFC Path ID field indicates the identifier of the target AFC path. In this example, AFCPID-1 is set. The Status field indicates the process result. In this example, “OK” indicating success of the process is set.

Next, AFC daemon-ini transmits the generated Split-Merge Reply message to the Initiator application (step S172).

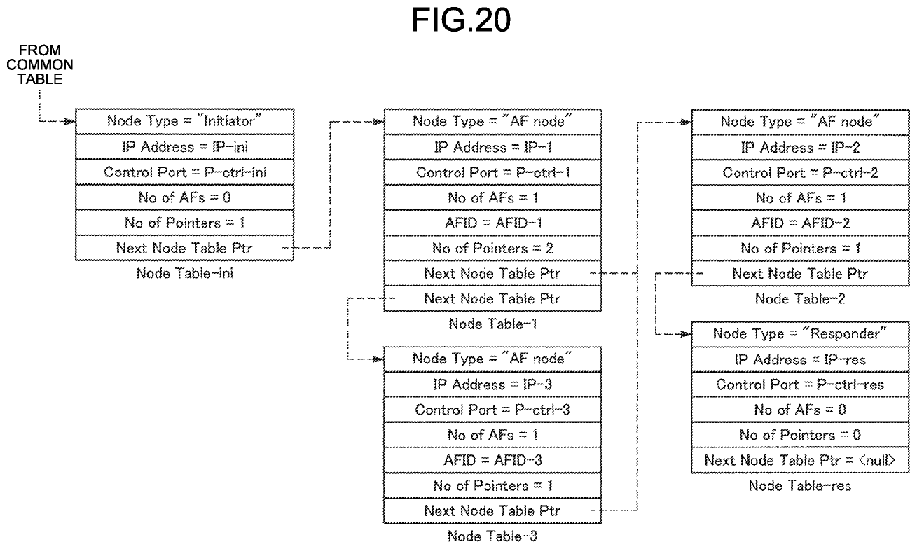

As a result of the process above, AFC daemon-ini holds Node Tables illustrated in FIG. 20. The other tables are not changed from FIG. 8. Compared with Node Tables illustrated in FIG. 8, Node Table-3 is added in FIG. 20. Hence, the value in the No of Pointers field of Node Table-1 is updated from 1 to 2, and the newly added Next Node Table Pointer field is set to point to Node Table-3. The Next Node Table Pointer field of Node Table-3 is set to point to Node Table-2.

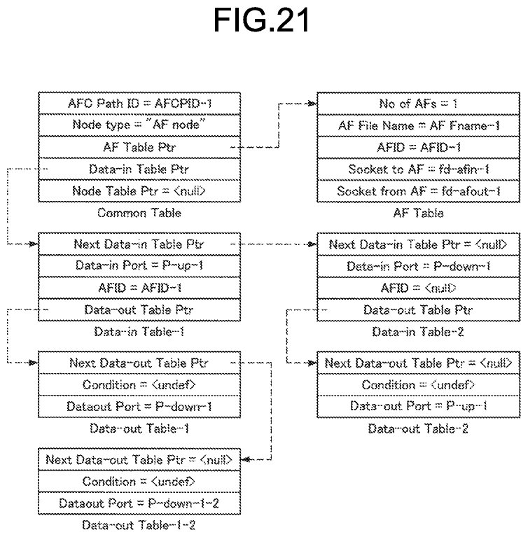

FIG. 21 illustrates the tables held by AFC daemon-1 after the process above. Compared with FIG. 9, Data-out Table-1-2 is added. Hence, the Next Data-out Table Pointer field of Data-out Table-1 is set to point to Data-out Table-1-2. In the Data-out Port field of Data-out Table-1-2, P-down-1-2 that is the port for downstream data communication newly provided in the process above is set.

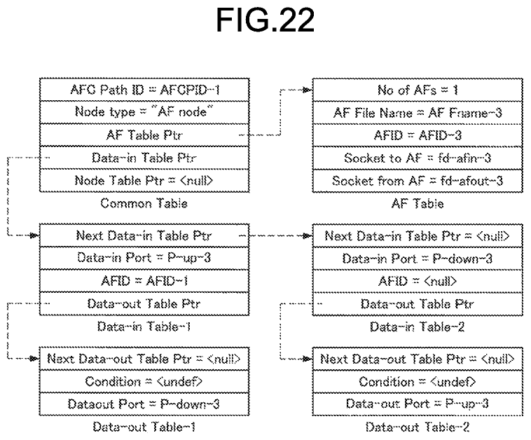

FIG. 22 illustrates the tables held by AFC daemon-3 after the process above. The contents are similar to those in FIG. 9 or FIG. 10.

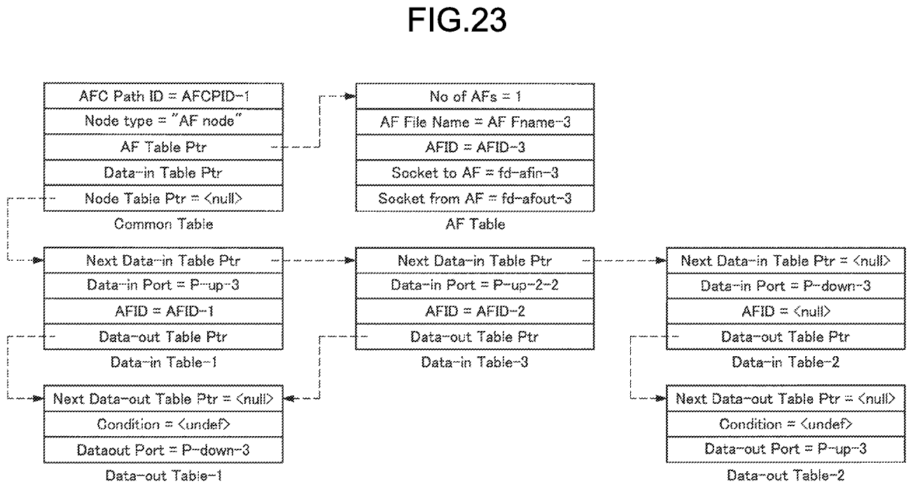

FIG. 23 illustrates the tables held by AFC daemon-2 after the process above. Compared with FIG. 10, Data-in Table-3 is added. In this example, the Next Data-in Table Pointer field of Data-in Table-1 points to Data-in Table-3, and the Next Data-in Table Pointer field of Data-in Table-3 points to Data-in Table-2. In the Data-in Port field of Data-in Table-3, P-up-2-2 that is the port for upstream data communication newly provided in the process above is set. The Data-out Table Pointer field is set to point to Data-out Table-1.

(Procedure of Setting Branch Condition)

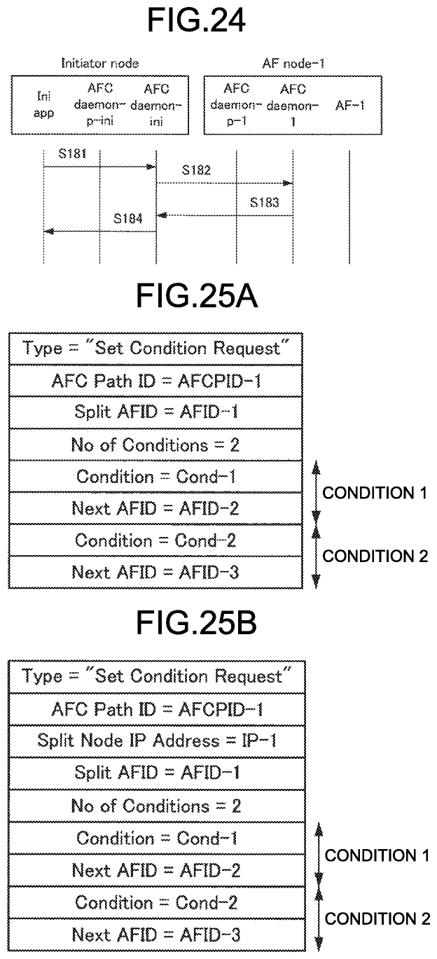

The procedure of setting a branch condition at AF-1 in the AFC path with branch and merge illustrated in FIG. 15 will now be described. FIG. 24 is a flowchart illustrating the procedure of setting a branch condition at AF-1 in the AFC path with branch and merge illustrated in FIG. 15. Here, the setting is such that when the process result of AF-1 satisfies Condition 1 (cond-1), AF-2 is subsequently executed, whereas when the process result of AF-1 satisfies Condition 2 (cond-2), AF-3 is subsequently executed.

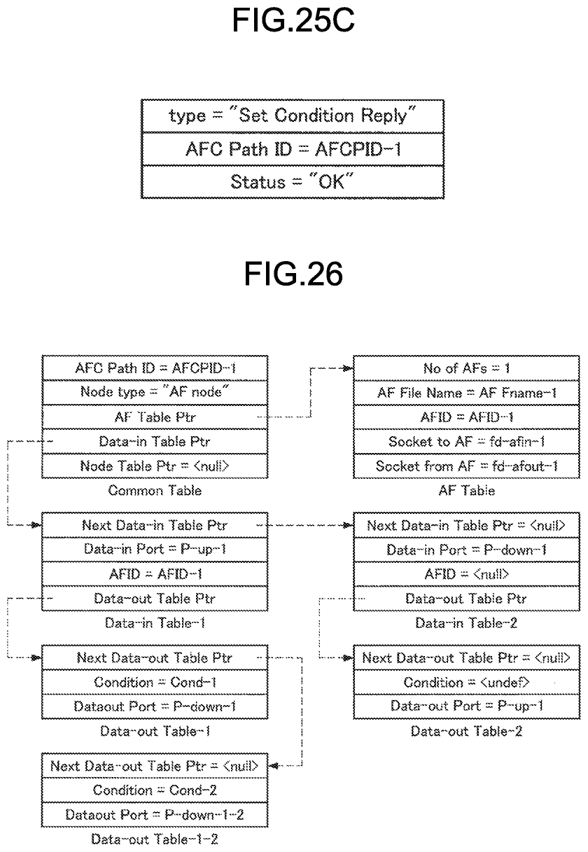

The Initiator application creates a Set Condition Request message. FIG. 25A illustrates an example of the Set Condition Request message created by the Initiator application. The fields will be described below. The Type field indicates a message type. In this example, “Set Condition Request” is set. The AFC Path ID field indicates the identifier of the target AFC path. In this example, AFCPID-1 is set. The Split AFID field indicates the identifier of the AF serving as a branch point. In this example, AFID-1 that is the identifier of AF-1 is set. The No of Conditions field indicates the number of conditions to be set. In this example, 2 is set. For each condition, the following two fields exist. In the Condition field, a condition is set. In Next AFID, the identifier of the subsequent AF when the condition in the Condition field is satisfied is set. In this example, the identifier of the subsequent AF when the process result of AF-1 satisfies the condition Cond-1 is AFID-1, and the identifier of the subsequent AF when the condition Cond-2 is satisfied is AFID-3.

Next, the Initiator application transmits the Set Condition Request message to AFC daemon-ini (step S181).

Upon receiving the Set Condition Request message, AFC daemon-ini creates a Set Condition Request packet. FIG. 25B illustrates a format example of the Set Condition Request packet created by AFC daemon-ini. In the Set Condition Request packet, compared with the Set Condition Request message illustrated in FIG. 25A, the Split Node IP Address field is added, and IP-1 that is the IP address of AF node-1 is set. AFC daemon-ini transmits the Set Condition Request packet to AFC daemon-1 (step S182).

AFC daemon-1 transmits a Set Condition Reply packet to AFC daemon-ini (step S183). FIG. 25C illustrates a format example of the Set Condition Reply packet. In the Type field, “Set Condition Reply” is set. In the AFC Path ID field, AFCPID-1 that is the identifier of the target AFC path is set. In the Status field, “OK” indicating success of the process is set.

AFC daemon-ini transmits a Set Condition Reply message in the same format as the Set Condition Reply packet to the Initiator application (step S184).

As a result of the process above, AFC daemon-1 holds the tables illustrated in FIG. 26. Compared with FIG. 21, cond-1 is set in the Condition field of Data-out Table-1, and cond-2 is set in the Condition field of Data-out Table-1-2.

(Procedure of Changing from Linear AFC Path to AFC Path Having Plurality of Responder Nodes)

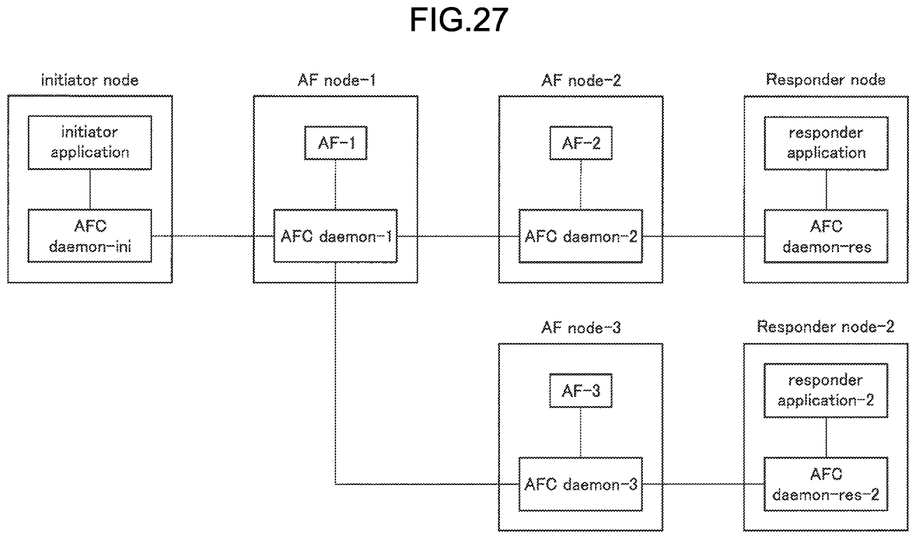

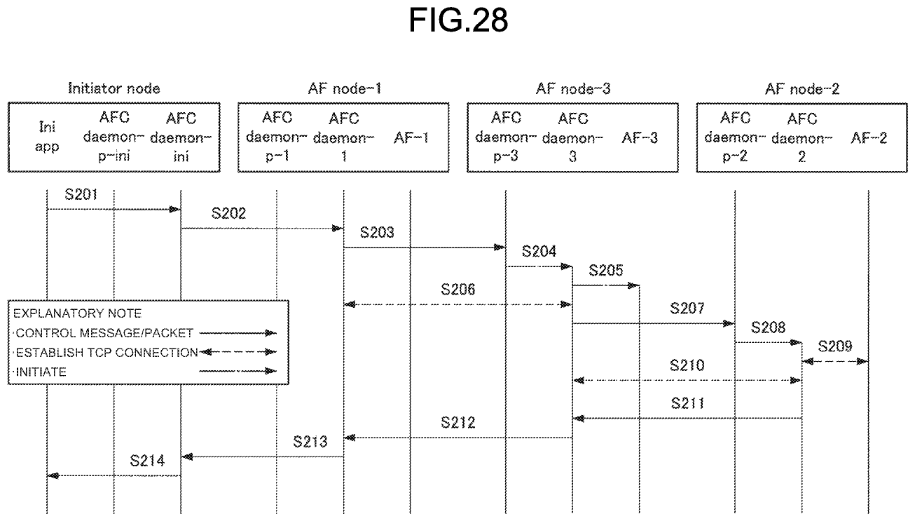

The procedure of changing the linear AFC path illustrated in FIG. 3 to an AFC path having a plurality of Responder nodes will now be described. FIG. 27 is a diagram illustrating an example of the AFC path having a plurality of Responder nodes. FIG. 28 is a flowchart illustrating the procedure of changing the linear AFC path illustrated in FIG. 3 to the AFC path illustrated in FIG. 27. In this figure, the description of AFC daemon-p is omitted. In this example, the AFC path branches at AF-1, AF-3 is initiated on AF node-3 on a new AFC path, and as the next stage of AF-3, the new AFC path is terminated by Responder application-2 on Responder node-2. It is assumed that the IP address of Responder node-2 is IP-res-2.

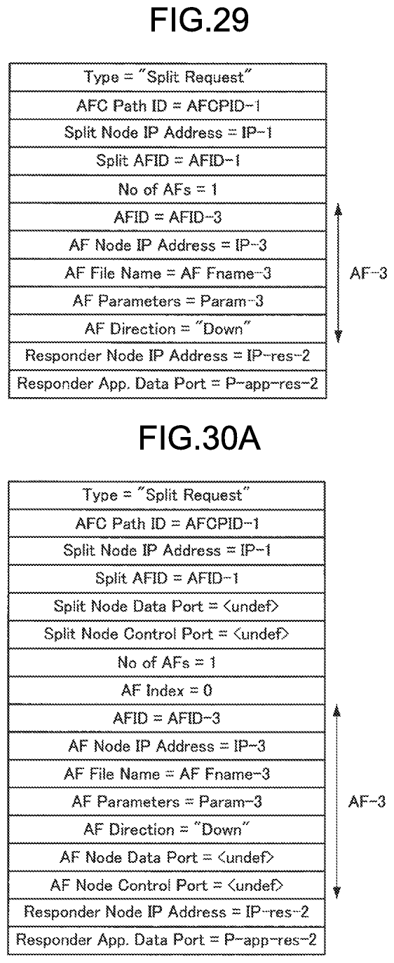

The Initiator application creates and transmits a Split Request message to AFC daemon-ini (step S201). FIG. 29 illustrates a format example of the Split Request message created by the Initiator application. The fields will be described below. The Type field indicates a message type. In this example, “Split Request” is set. The AFC Path ID field indicates the identifier of the target AFC path. In this example, AFCPID-1 is set. The Split Node IP Address field indicates the IP address of the AF node at which the AFC path branches. In this example, IP-1 that is the IP address of AF node-1 is set. The Split AFID field indicates the identifier of the AF at which the AFC path branches. In this example, AFID-1 that is the identifier of AF-1 is set. The No of AFs field indicates the number of AFs initiated on the split new AFC path. In this example, 1 is set. For each AF, five fields exist: the AFID field, the AF Node IP Address field, the AF File Name field, the AF Parameters field, and the AF Direction field. The roles and the values of these five fields are similar to the corresponding fields of the Split-Merge Request message illustrated in FIG. 17. The Responder Node IP Address field indicates the IP address of the Responder node. In this example, IP-res-2 that is the IP address of Responder node-2 is set. The Responder Application Data Port field indicates a port for data communication of the Responder application. In this example, P-app-res-2 is set.

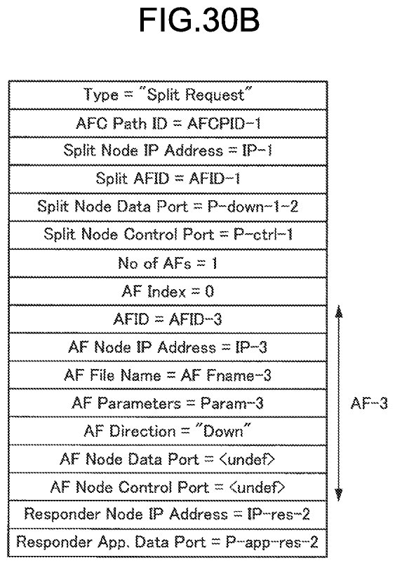

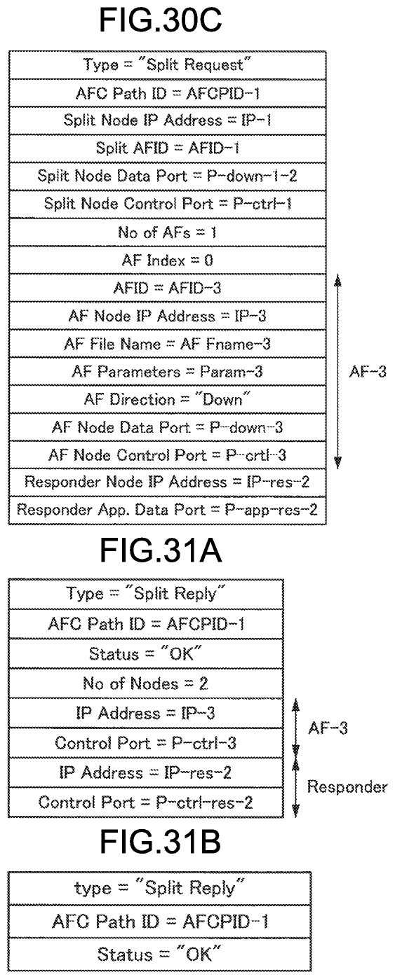

Upon receiving the Split Request message, AFC daemon-ini creates and transmits a Split Request packet to AFC daemon-1 (step S202). FIG. 30A illustrates a format example of the Split Request packet created by AFC daemon-ini. The fields will be described below. The Type field indicates a packet type. In this example, “Split Request” is set. The AFC Path ID field indicates the identifier of the target AFC path. In this example, AFCPID-1 is set. the Split Node IP Address field indicates the IP address of the AF node at which the AFC path branches. In this example, IP-1 that is the IP address of AF node-1 is set. The Split AFID field indicates the identifier of the AF at which the AFC path branches. In this example, AFID-1 that is the identifier of AF-1 is set. The No of AFs field indicates the number of AFs initiated on the split new AFC path. In this example, 1 is set.

For each AF, seven fields exist: the AFID field, the AF Node IP Address field, the AF File Name field, the AF Parameters field, the AF Direction field, the AF Nnode Data Port field, and the AF Node Control Port field. The roles and the values of these seven fields are similar to the corresponding fields of the Split-Merge Request packet illustrated in FIG. 18A.

The Responder Node IP Address field indicates the IP address of the Responder node. In this example, IP-res-2 that is the IP address of Responder node-2 is set. The Responder Application Data Port field indicates the port for data communication of the Responder application. In this example, P-app-res-2 that is the port for data communication of Responder Application-2 is set.

Upon receiving the Split Request packet, AFC daemon-1 finds that its node is a branch node, from the value in the Split AF node IP Address field. Then, P-down-1-2 is created as a new port for data communication for branching. Next, AFC daemon-1 transmits a Split Request packet to AFC daemon-p-3 as a branch destination (step S203). FIG. 30B illustrates a format example of the Split Request packet transmitted by AFC daemon-1. In the Split Request packet illustrated in FIG. 30B, P-down-1-2 and P-ctrl-1 are set in the Split Node Data Port field and the Split Node Control Port field, respectively, in comparison to the Split Request packet illustrated in FIG. 30A.

Upon receiving the Split Request packet, AFC daemon-p-3 initiates AFC daemon-3 (step S204). The subsequent process is executed by AFC daemon-3.

AFC daemon-3 recognizes that its node is an AF node, from the values in the AF Index field and the AF Node IP Address field. AFC daemon-3 executes AF Fname-3 indicated by the AF File Name field, using Param-3 indicated by the AF Parameters field of the Split Request packet as a parameter, and initiates AF-3 (step S205). For the mentioned operation, the standard input and the standard output of AF-3 are connected to fd-afin-3 and fd-afout-3 that are the sockets of AFC daemon-3.

AFC daemon-3 creates P-up-3 as a port for upstream data communication and P-down-3 as a port for downstream data communication. Next, AFC daemon-3 establishes a TCP connection between P-up-3 that is the port for upstream data communication and P-down-1-2 that is the port for downstream data communication of AFC daemon-1 (step S206).

AFC daemon-3 increments the value in the AF Index field of the Split Request packet. As a result, the value changes to 1, which is equal to the value in the No of AFs field, so that AFC daemon-3 recognizes that the next stage of the AFC path is a Responder node. AFC daemon-3 then transmits a Split Request packet to AFC daemon-p-res-2 (step S207). FIG. 30C is a format example of the Split Request packet transmitted by AFC daemon-3. In the Split Request packet illustrated in FIG. 30C, P-down-3 and P-ctrl-3 are set in the AF Data Port field and the AF Control Port field, respectively, for AF-3, in comparison to the Split Request packet illustrated in FIG. 30B.

Upon receiving the Split Request packet, AFC daemon-res-2 initiates AFC daemon-res-2 (step S208). The subsequent process is executed by AFC daemon-res.

AFC daemon-res-2 recognizes that its node is a Responder node, from the value in the Responder Node IP Address field of the Split Request packet. AFC daemon-res-2 creates P-res-2 as a port for data communication with an application and establishes a TCP connection with Responder application-res-2 (step S209).

Subsequently, AFC daemon-res-2 creates P-up-res-2 as a port for upstream data communication and establishes a TCP connection with AFC daemon-3 (step S210).

Subsequently, AFC daemon-res-2 creates and transmits a Split Reply packet to AFC daemon-3 (step S211). FIG. 31A illustrates a format example of the Split Reply packet transmitted by AFC daemon-res-2. In the Type field, “Split Reply” that is a packet type is set. In the AFC Path ID field, AFCPID-1 that is the identifier of the target AFC path is set. In the Status field, “OK” indicating success of the process is set. In the No of Nodes field, the number of nodes newly added, 2 is set.

For each newly added node, the IP Address field and the Control Port field exist. In this example, IP-3 and P-ctrl-3 are set for AF node-3, and IP-res-2 and P-ctrl-res-2 are set for Responder node-2.

Upon receiving the Split Reply packet, AFC daemon-3 forwards this to AFC daemon-1 (step S212).

Upon receiving the Split Reply packet, AFC daemon-1 forwards this to AFC daemon-ini (step S213).

Upon receiving the Split Reply packet, AFC daemon-ini creates and transmits a Split Reply message to the Initiator application (step S214). FIG. 31B illustrates a format example of the Split Reply message created by AFC daemon-ini. In the Type field, “Split Reply” that is a message type is set. In the AFC Path ID field, AFCPID-1 that is the identifier of the target AFC path is set. In the Status field, “OK” indicating success of the process is set.

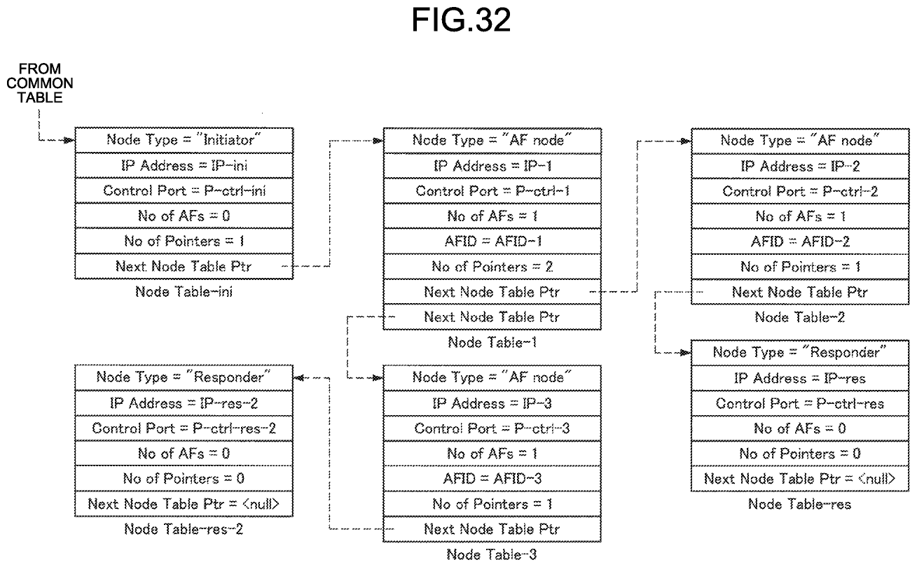

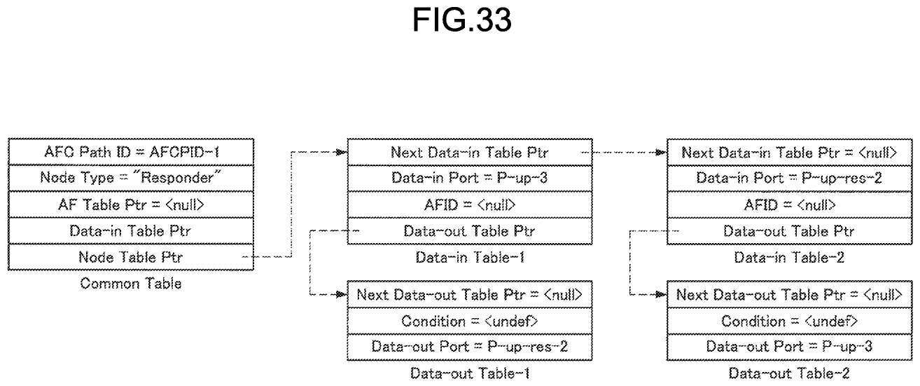

As a result of the process above, AFC daemon-ini holds Node Tables illustrated in FIG. 32. In Node Tables illustrated in FIG. 32, Node Table-3 and Node Table-res-2 are added, in comparison to Node Tables illustrated in FIG. 8. Since the AFC path branches at AF node-1, in Node Table-1, the value in the No of Pointers field is 2, and one Next Node Table Pointer field is added. The added Next Node Table Pointer field points to Node Table-3. The Next Node Table Pointer field in Node Table-3 points to Node Table-res-2. The tables held by AFC daemon-1 are similar to those in FIG. 21. The tables held by AFC daemon-3 are similar to those in FIG. 22. FIG. 33 illustrates the tables held by AFC daemon-res-2. The contents are similar to those in FIG. 11.

(Procedure of Changing from Linear AFC Path to AFC Path Having Plurality of Initiator Nodes)

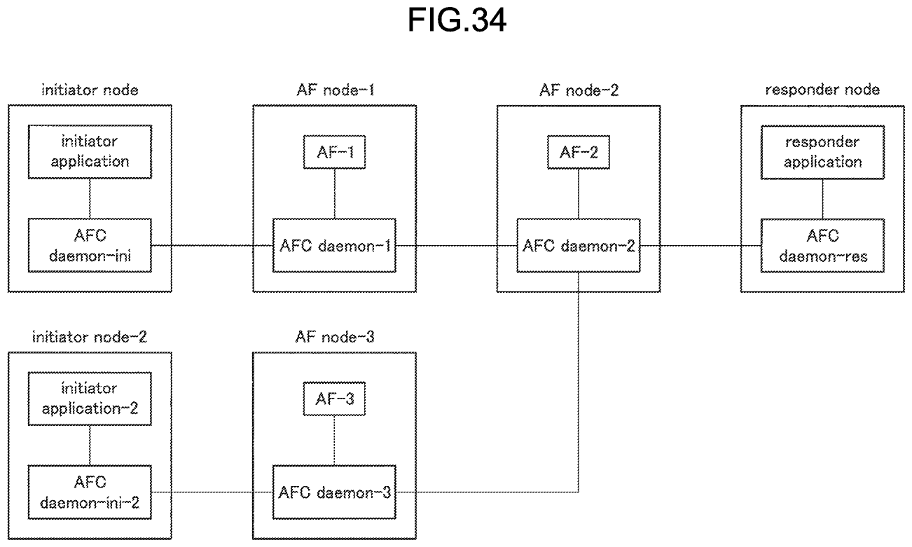

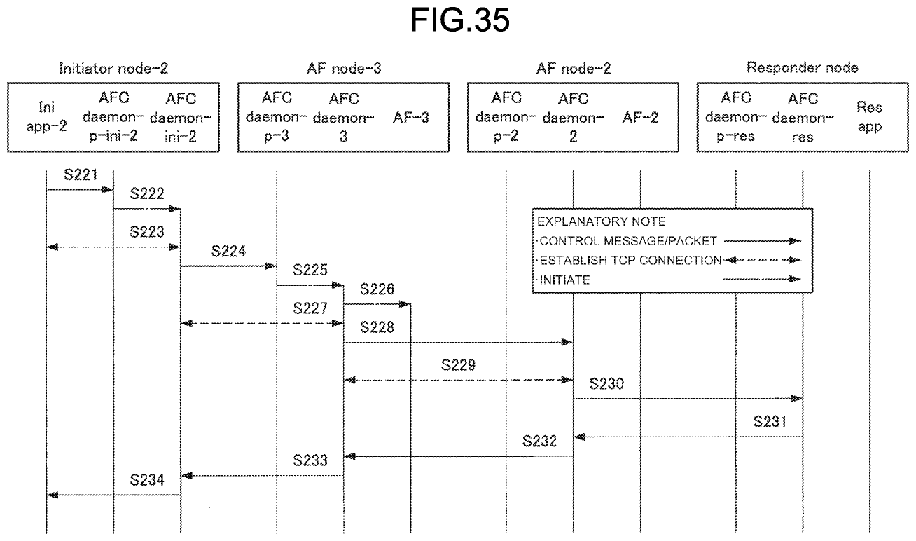

The procedure for changing the linear AFC path illustrated in FIG. 3 to the shape having a plurality of Initiator nodes will now be described. FIG. 34 is a diagram illustrating an example of the AFC path having a plurality of Initiator nodes. FIG. 35 is a diagram illustrating an example of the procedure of changing a linear AFC path to an AFC path having a plurality of Initiator nodes. In this figure, the description of AFC daemon-p is omitted. In this example, Initiator application-2 operating on Initiator node-2 and AF-3 operating on AF node-3 are added as a new AFC path, and two AFC paths merge at AF-2 operating on AF node-2. It is assumed that the IP address of Initiator node-2 is IP-ini-2.

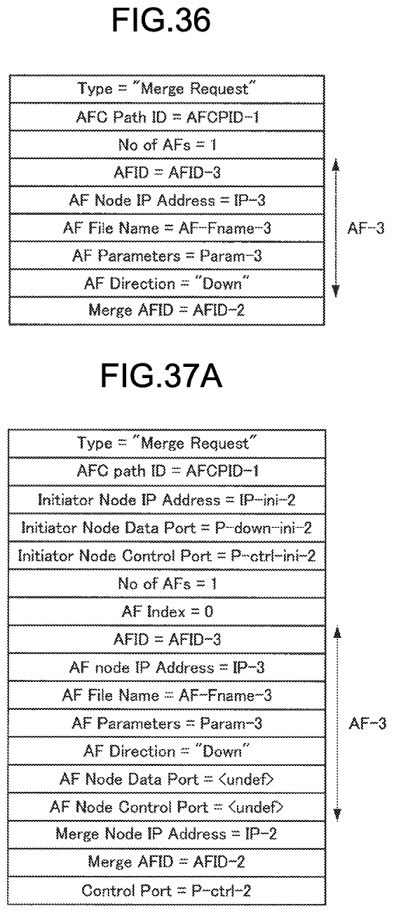

Initiator application-2 creates and transmits a Merge Reqeuest message to AFC daemon-p-ini-2 (step S221). FIG. 36 illustrates a format example of the Merge Reqeuest message created by Initiator application-2. The fields are described. In the Type field, “Merge Request” indicating a message type is set. In the AFC Path ID field, AFCPID-1 that is the identifier of the target AFC path is set. The No of AFs field indicates the number of AFs newly added. In this example, 1 is set.

For each newly added AF, five fields exist: the AFID field, the AF Node IP Address field, the AF File Name field, the AF Parameters field, and the AF Direction field. The roles and the values of these five fields are similar to the corresponding fields of the Split-Merge Request message illustrated in FIG. 17. In the Merge AFID field, AFID-2 that is the identifier of the AF to be merged is set.

Upon receiving the Merge Request message, AFC daemon-p-ini-2 initiates AFC daemon-ini-2 (step S222). The subsequent process is executed by AFC daemon-ini-2.

AFC daemon-ini-2 creates P-ini-2 as a port for data communication with Initiator application-2, P-ctrl-ini-2 as a port for control packet, and P-down-ini-2 as a port for data communication in the downstream direction. Next, AFC daemon-ini-2 establishes a TCP connection with Initiator application-2 (step S223).

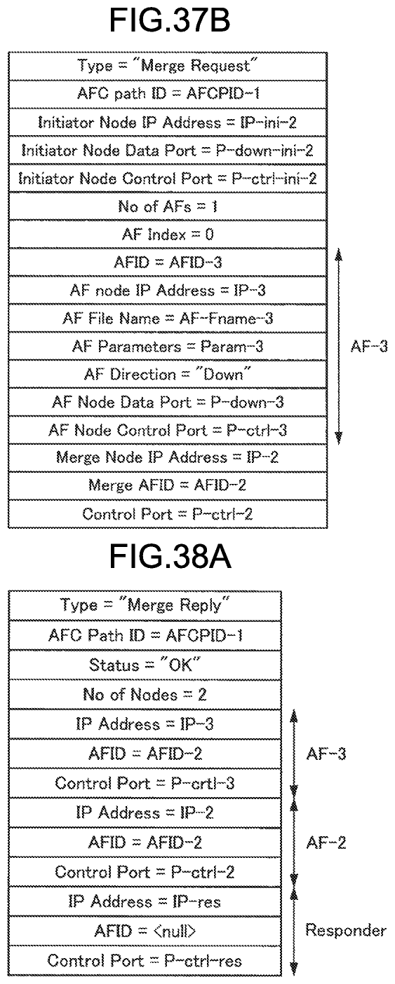

AFC daemon-ini-2 creates and transmits a Merge Request packet to AFC daemon-p-3 (step S234). FIG. 37A illustrates a format example of the Merge Request packet created by AFC daemon-ini-2. The fields are described. In the Type field, “Merge Request” indicating a packet type is set. The AFC Path ID field indicates the identifier of the AFC path to be established. In this example, AFCPID-1 is set. In the Initiator Node IP Address field, IP-ini-2 that is the IP address of Initiator node-2 is set. In the Initiator Node Data Port field, P-down-ini that is a port for data communication in the downstream direction of AFC daemon-ini is set. In the Initiator Node Control Port field, P-ctrl-ini that is a port for control packet transmission/reception of AFC daemon-ini is set. The No of AFs field indicates the number of AFs to be initiated. In this example, 1 is set. The AF Index field indicates what order of AF is the process target at present.

In each AF, seven fields exist: the AFID field, the AF Node IP Address field, the AF File Name field, the AF Parameters field, the AF Direction field, the AF Node Data Port field, and the AF Node Control Port field. The roles and the values of these seven fields are similar to the corresponding fields of the Split-Merge Request packet illustrated in FIG. 18. At this point of time, for the AF node, the values in the Data Port field and the Control Port field are not yet determined. In the Merge Node IP address field, IP-2 that is the IP address of the node (AF node-2) at which AFC paths merge is set. In the Merge AFID field, AFID-2 that is the identifier of the AF at which the AFC paths merge is set. In the Merge Node Control Port field, P-ctrl-2 that is the port number for control message of the node at which the AFC paths merge is set.

Upon receiving the Merge Request packet, AFC daemon-p-3 initiates AFC daemon-3 (step S225). The subsequent process is executed by AFC daemon-3.

AFC daemon-3 recognizes that its node is an AF node, from the value (0) in the AF Index field of the Merge Request packet and the value in the AF Node IP Address field. AFC daemon-3 executes AF Fname-3 indicated by the AF File Name field, using Param-3 indicated by the AF Parameters field of the Merge Request packet as a parameter, and initiates F-3 (step S226). For the mentioned operation, the standard input and the standard output of AF-3 are connected to fd-afin-3 and fd-afout-3 that are the sockets of AFC daemon-3.

AFC daemon-3 creates P-up-3 as a port for upstream data communication, P-down-3 as a port for downstream data communication, and P-ctrl-3 as a port for control communication. Next, AFC daemon-3 establishes a TCP connection between P-up-3 that is the port for upstream data communication and P-down-ini-2 that is the port for downstream data communication of AFC daemon-ini-2 (step S227).

AFC daemon-3 increments the value in the AF Index field of the Merge Request packet. As a result, the value changes to 1, which is equal to the value in the No of AFs field, so that AFC daemon-3 recognizes that the next stage of the AFC path is a Merge node. AFC daemon-3 then transmits a Merge Request packet to AFC daemon-2 (step S228). FIG. 37B illustrates a format example of the Merge Request packet transmitted by AFC daemon-3. In the Merge request packet illustrated in FIG. 37B, P-down-3 and P-ctrl-3 are set in the AF Node Data Port field and the AF Node the Control Port field, respectively, in comparison to the Merge request packet illustrated in FIG. 37A.

AFC daemon-2 establishes a TCP connection between P-up-2 that is the port for upstream data communication and P-down-3 that is the port for downstream data communication of AFC daemon-3 (step S229).

Subsequently, AFC daemon-2 transmits a Merge Request packet to AFC daemon-res (step S230). FIG. 37B illustrates a format example of the Merge Request packet transmitted by AFC daemon-2.

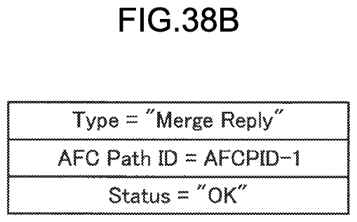

AFC daemon-res creates and transmits a Merge Reply packet to AFC daemon-2 (step S231). FIG. 38A is a format example of the Merge Reply packet created by AFC daemon-res. In the Type field, “Merge Reply” indicating a packet type is set. In the AFC Path ID field, AFCPID-1 that is the identifier of the target AFC path is set. In the Status field, “OK” indicating success of the process is set. The No of Nodes field indicates the number of AF nodes and Responder node included in the newly established AFC path. In this example, 3 (AF node-3, AF node-2, Responder Node) is set. For each node, the IP Address field, the AFID field, and the Control Port field exist. In this example, IP-3, AFID-3, and P-ctrl-3 are set for AF node-3, IP-2, AFID-2, and P-ctrl-2 are set for AF node-2, and IP-res, “null”, and P-ctrl-res are set for the Responder node.

Upon receiving the Merge Reply packet, AFC daemon-2 forwards the Merge Reply packet to AFC daemon-3 (step S232).

Upon receiving the Merge Reply packet, AFC daemon-3 forwards the Merge Reply packet to AFC daemon-ini-2 (step S233).

Upon receiving the Merge Reply packet, AFC daemon-ini-2 creates and transmits a Merge Reply message to Initiator application-2. FIG. 38B illustrates a format example of the Merge Reply message created by AFC daemon-ini-2. In the Type field, “Merge Reply” indicating a message type is set. In the AFC Path ID field, AFCPID-1 that is the identifier of the target AFC path is set. In the Status field, “OK” indicating success of the process is set.

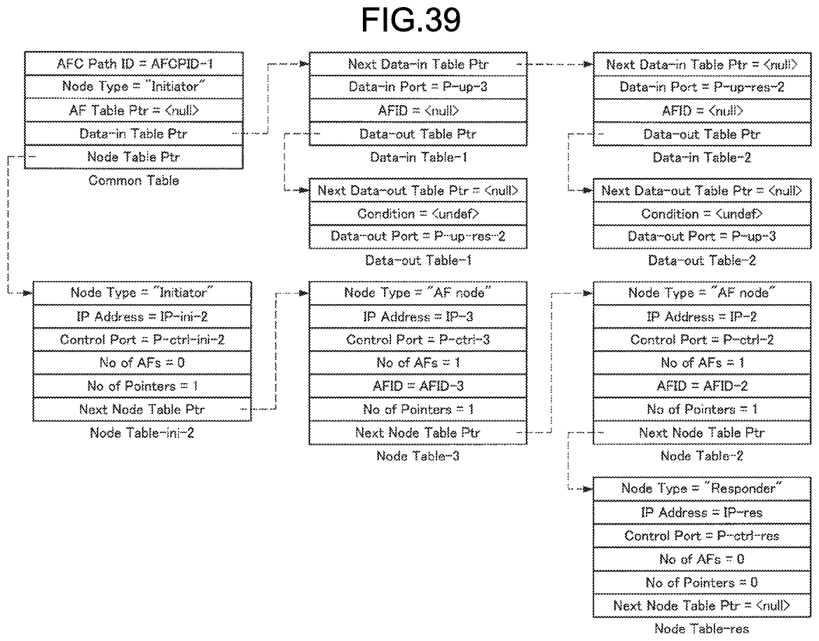

As a result of the process above, AFC daemon-ini-2 holds the tables illustrated in FIG. 39. Node Tables held by AFC daemon-ini-2 include Initiator node-2, AF node-3, AF node-2, and Responder node, which are nodes belonging to the newly established AFC path. AFC daemon-3 holds the same tables as in FIG. 22. AFC daemon-2 holds the same tables as in FIG. 23.

(Procedure of Inserting AF)

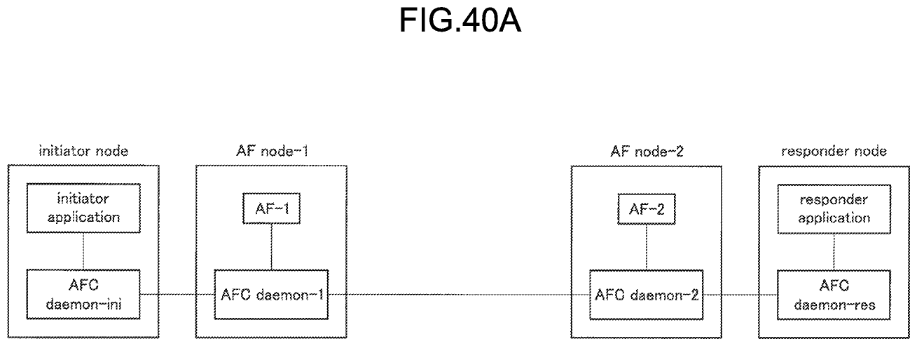

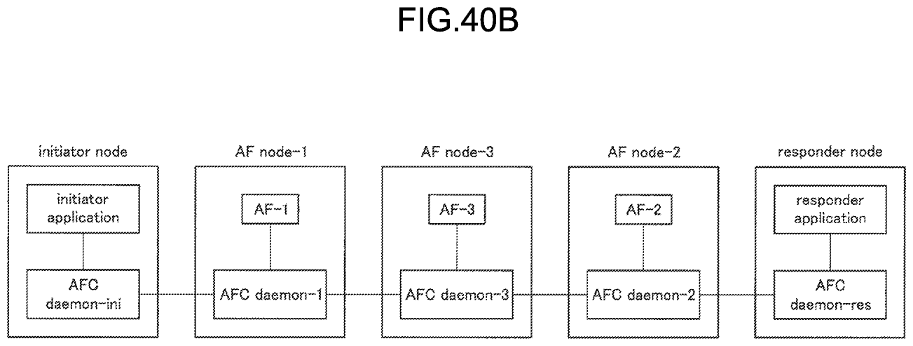

The procedure of inserting a new AF to the existing AFC path will now be described. FIG. 40A illustrates an example of the existing AFC path, and FIG. 40B is a diagram illustrating insertion of AF-3 between AF-1 and AF-2 in the AFC path illustrated in FIG. 40A. In this figure, the description of AFC daemon-p is omitted.

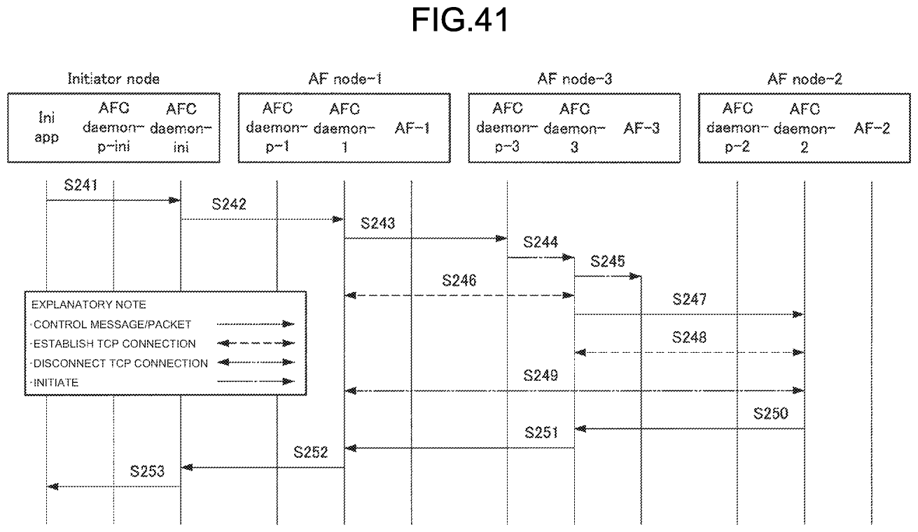

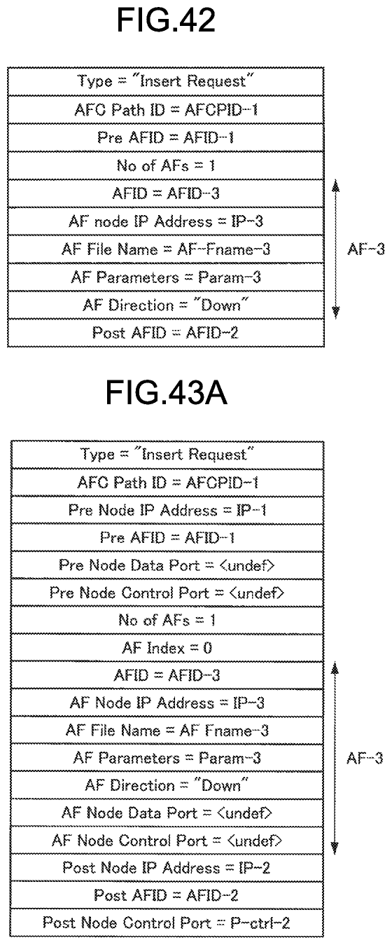

FIG. 41 is a diagram illustrating an example of the AF process procedure. The Initiator application transmits an Insert Request message to AFC daemon-p-ini (step S241). FIG. 42 illustrates a format example of the Insert Request message transmitted by the Initiator application. The fields will be described below. In the Type field, “Insert Request” that is a message type is specified. In the AFC Path ID field, AFCPID-1 that is the identifier of the target AFC path is specified. In the Pre AFID field, AFID-1 that is the identifier of the AF immediately before the AF to be inserted is specified. In the No of AFs field, the number of AFs to be inserted, 1 is specified.

For each AF to be inserted, five fields exist: the AFID field, the AF Node IP Address field, the AF File Name field, the AF Parameters field, and the AF Direction field. The roles and the values of these five fields are similar to the corresponding fields of the Split-Merge Request message illustrated in FIG. 17. In the Post AFID field, AFID-2 that is the identifier of the AF immediately after the AF to be inserted is specified.

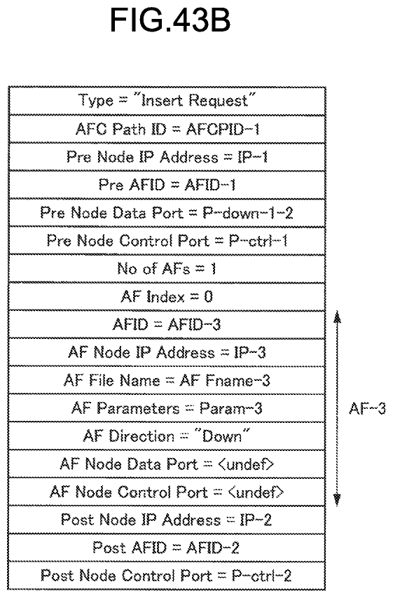

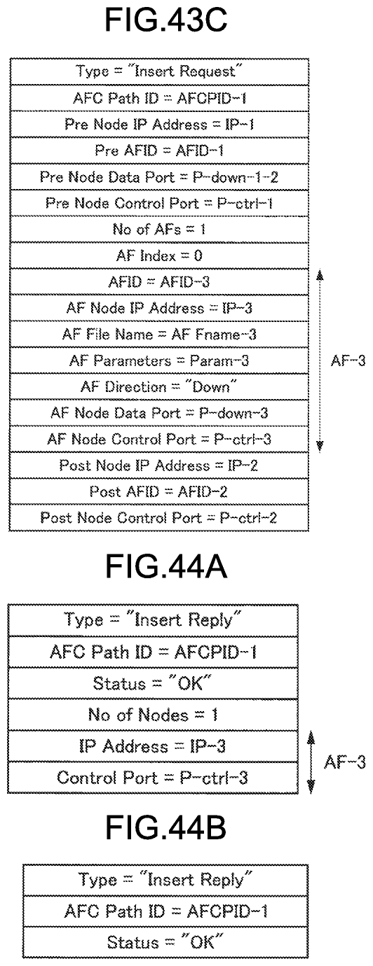

Upon receiving the Insert Request message, AFC daemon-ini creates and transmits an Insert Request packet to AFC-daemon-1 (step S242). FIG. 43A is a format example of the Insert Request packet created by AFC daemon-ini. The fields will be described below. In the Type field, “Insert Request” that is a message type is specified. In the AFC Path ID field, AFCPID-1 that is the identifier of the target AFC path is specified. In the Pre Node IP Address field, IP-1 that is the IP address of the AF node immediately before the AF to be inserted is specified. In the Pre AFID field, AFID-1 that is the identifier of the AF immediately before the AF to be inserted is specified. In the No of AFs field, the number of AFs inserted, 1 is specified. The AF Index field indicates what order of AF is the process target at present. In this example, 0 is set.

For each AF to be inserted, seven fields exist: the AFID field, the AF Node IP Address field, the AF File Name field, the AF Parameters field, the AF Direction field, the AF Node Data Port field, and the AF Node Control Port field. The roles and the values of these seven fields are similar to the corresponding fields of the Split-Merge Request packet illustrated in FIG. 18. In the Post Node IP Address field, IP-2 that is the IP address of the AF node immediately after the AF node to be inserted is specified. In the Post AFID field, AFID-2 that is the identifier of the AF immediately after the AF to be inserted is specified. In the Post Node Control Port field, P-ctrl-2 that is the port number for control packet of the AF node immediately after the AF node to be inserted is specified.

Upon receiving the Insert Request packet, AFC daemon-1 recognizes that its node is the AF node immediately before the AF node to be inserted, from the value in the Pre Node IP Address field, and creates a new port for data communication for downstream P-down-1-2. Next, AFC daemon-1 transmits the Insert Request packet to AFC daemon-p-3 (step S243). FIG. 43B illustrates a format example of the Insert Request packet transmitted by AFC daemon-1. In the Insert Request packet illustrated in FIG. 43B, P-down-1-2 and P-ctrl-1 are set in the Pre Node Data Port field and the Pre Node Control Port field, respectively, in comparison to the Insert Request packet illustrated in FIG. 43A.

Upon receiving the Insert Request packet, AFC daemon-p-3 initiates AFC daemon-3 (step S244). The subsequent process is performed by AFC daemon-3. AFC daemon-p-3 recognizes that its node is an AF node, from the value in the AF Index field and the value in the No of AFs field.

AFC daemon-3 executes AF Fname-3 indicated by the AF File Name field, using Param-3 indicated by the AF Parameters field of the Insert Request packet as a parameter, and initiates AF-3 (step S245). For the mentioned operation, the standard input and the standard output of AF-3 are connected to fd-afin-3 and fd-afout-3 that are the sockets of AFC daemon-3.

AFC daemon-3 creates P-up-3 as a port for upstream data communication, P-down-3 as a port for downstream data communication, and P-ctrl-3 as a port for a control packet. Next, AFC daemon-3 establishes a TCP connection between P-up-3 that is the port for upstream data communication and P-down-1-2 that is the port for downstream data communication of AFC daemon-1 (step S246).

AFC daemon-3 increments the value in the AF Index field of the Insert Request packet. As a result, the value in the AF Index field changes to 1, which is equal to the value in the No of AFs field. Hence, AFC daemon-3 recognizes that its node is the last insertion AF node and transmits an Insert Request packet to AFC daemon-2 (step S247). FIG. 43C illustrates a format example of the Insert Request packet transmitted by AFC daemon-3. In the Insert Request packet illustrated in FIG. 43C, P-down-3 and P-ctrl-3 are set in the AF Node Data Port field and the AF Node Control Port field, respectively, in comparison to the Insert Request packet illustrated in FIG. 43B.

Upon receiving the Insert Request packet, AFC daemon-2 recognizes that its node is the AF node immediately after the AF node to be inserted, from the value in the Post Node IP Address field. P-up-2-2 is then created as a new port for upstream data communication, and a TCP connection is established with P-down-3 that is the port for downstream data communication of AFC daemon-3 (step S248).

Subsequently, AFC daemon-2 disconnects the established TCP connection with AFC daemon-1 (step S249).

Subsequently, AFC daemon-2 transmits an Insert Reply packet to AFC daemon-3 (step S250). FIG. 44A illustrates a format example of the Insert Reply packet transmitted by AFC daemon-2. The fields will be described below. In the Type field, “Insert Reply” that is a packet type is specified. In the AFC Path ID field, AFCPID-1 that is the identifier of the target AFC path is specified. In the Status field, “OK” indicating success of the process is specified. In the No of Nodes field, the number of AFs inserted, 1 is specified. For each inserted AF, the IP Address field and Control Port exist. In this example, IP-3 and P-ctrl-3 are set.

Upon receiving the Insert Reply packet, AFC daemon-3 forwards the Insert Reply packet to AFC daemon-1 (step S251).

Upon receiving the Insert Reply packet, AFC daemon-1 disconnects the established TCP connection with AFC daemon-2 in accordance with step S249. Next, AFC daemon-1 forwards the Insert Reply packet to AFC daemon-ini (step S252).

Upon receiving the Insert Reply packet, AFC daemon-ini transmits an Insert Reply message to the Initiator application (step S253). FIG. 44B illustrates a format example of the Insert Reply message transmitted by AFC daemon-ini. In the Type field, “Insert Reply” that is a message type is specified. In the AFC Path ID field, AFCPID-1 that is the identifier of the target AFC path is specified. In the Status field, “OK” indicating success of the process is specified.

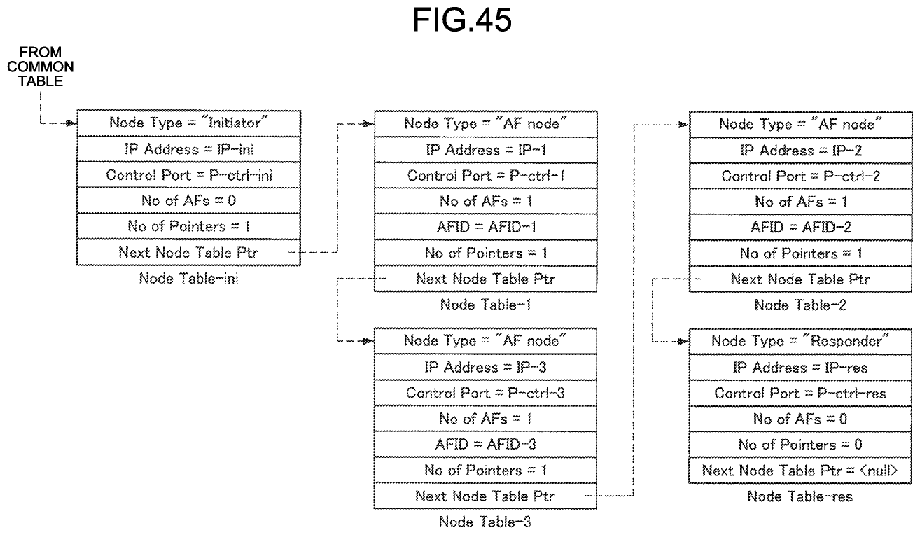

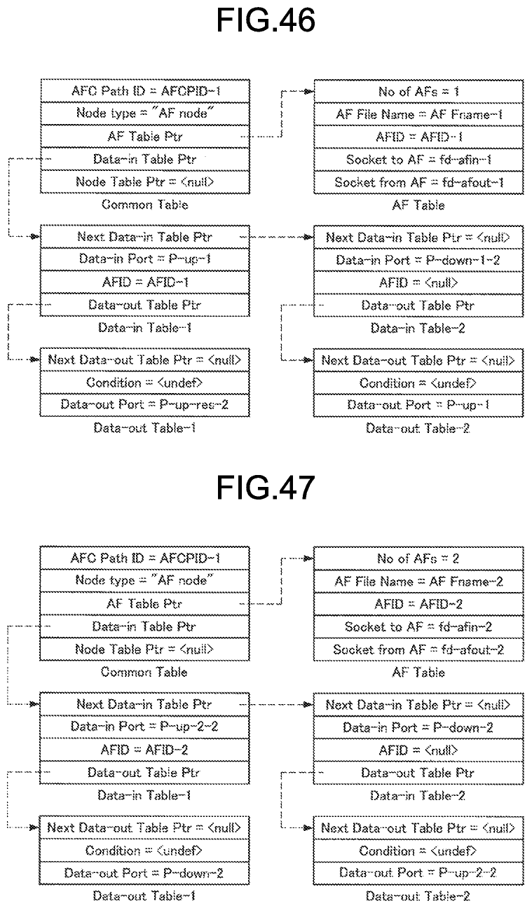

As a result of the process above, AFC daemon-ini holds Node Tables illustrated in FIG. 45. In Node Tables illustrated in FIG. 45, Node Table-3 is inserted between Node Table-1 and Node Table-2, in comparison to Node Tables illustrated in FIG. 8. FIG. 46 illustrates the tables held by AFC daemon-1. The tables held by AFC daemon-3 are the same as in FIG. 22. FIG. 47 illustrates the tables held by AFC daemon-2.

(Procedure of Deleting AF)

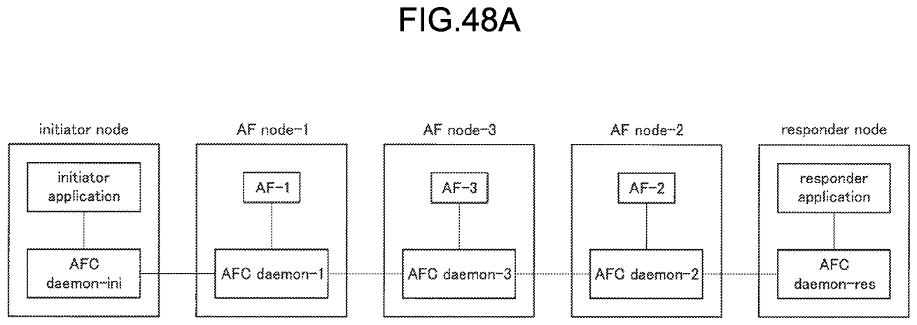

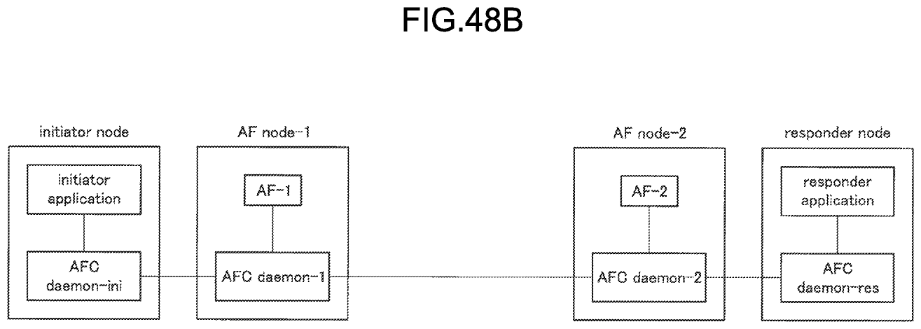

An example of deleting an AF from the existing AFC path will now be described. FIG. 48A illustrates an example of an AFC path before an AF is deleted, and FIG. 48B is a diagram illustrating deletion of AF-3 from the AFC path in FIG. 48A. In this figure, the description of AFC daemon-p is omitted.

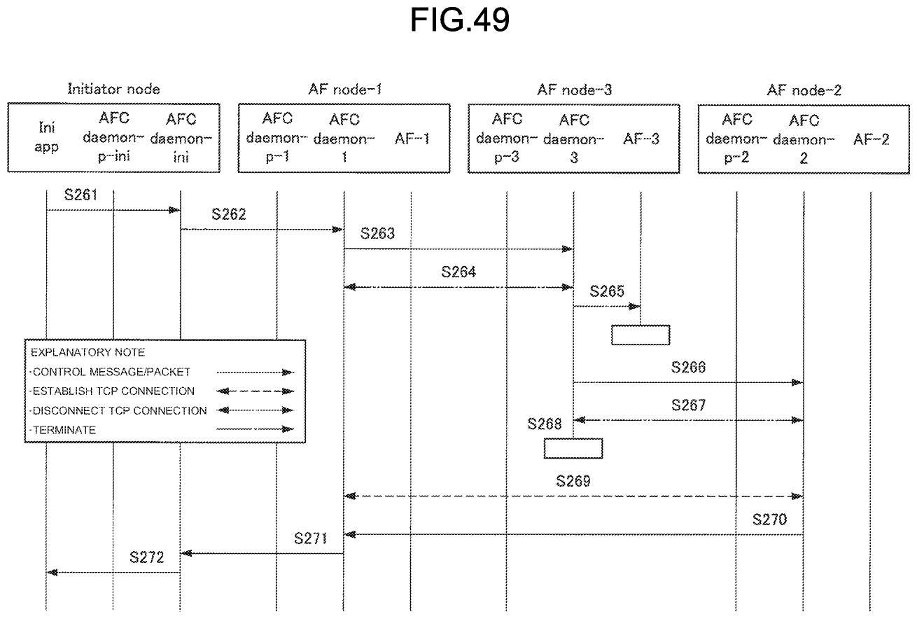

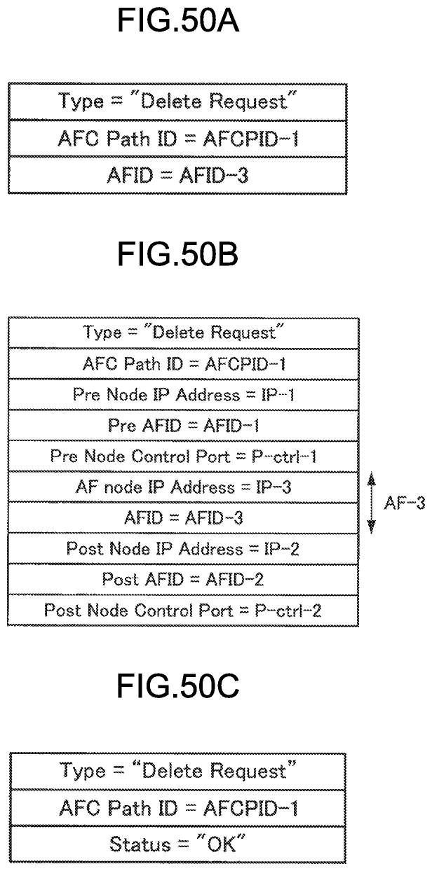

FIG. 49 is a flowchart illustrating the procedure of deleting an AF from the existing AFC path. First, the Initiator application creates a Delete Request message. FIG. 50A illustrates a format example of the Delete Request message created by the Initiator application. The fields will be described below. In the Type field, “Delete Request” indicating a message type is set. In the AFC path ID field, AFCPID-1 that is the identifier of the target AFC path is set. In the AFID field, AFID-3 that is the identifier of the AF to be deleted is set. Next, the Initiator application transmits the Delete Request message to AFC daemon-ini (step S261).

Upon receiving the Delete Request message, AFC daemon-ini creates and transmits a Delete Request packet to AFC daemon-(step S262). FIG. 50B illustrates a format example of the Delete Request packet created by AFC daemon-ini. The fields will be described below. In the Type field, “Delete Request” indicating a message type is set. In the AFC path ID field, AFCPID-1 that is the identifier of the target AFC path is set. In the Pre Node IP address field, IP-1 that is the IP address of the AF node at the stage preceding the AF to be deleted is set. In the Pre AFID field, AFID-1 that is the identifier of the AF at the stage preceding the AF to be deleted is set. In the AFID field, AFID-3 that is the identifier of the AF to be deleted is set.

Upon receiving the Delete Request packet, AFC daemon-1 recognizes that its node is the node at the stage preceding the deletion target AF and creates a new port for downstream data communication P-down-1-3. Next, AFC daemon-1 transmits the Delete Request packet to AFC daemon-3 (step S263).

Upon receiving the Delete Request packet, AFC daemon-3 disconnects the TCP connection with AFC daemon-1 (step S264).

Subsequently, AFC daemon-3 terminates AF-3 (step S265).

Subsequently, AFC daemon-3 transmits the Delete Request packet to AFC daemon-2 (step S266).

Upon receiving the Delete Request packet, AFC daemon-2 disconnects the TCP connection with AFC daemon-3 (step S267).

AFC daemon-3 terminates execution (step S268).

Upon receiving the Delete Request packet, AFC daemon-2 establishes a TCP connection with AFC daemon-1 that is the stage preceding the deletion target AF (step S269).

Subsequently, AFC daemon-2 creates a Delete Reply packet and transmits the Delete Reply packet to AFC daemon-1 (step S270). FIG. 50C illustrates a format example of the Delete Reply packet created by AFC daemon-2. The fields will be described below. In the Type field, “Delete Reply” indicating a packet type is set. In the AFC Path ID field, AFCPID-1 that is the identifier of the target AFC path is set. In the Status field, “OK” indicating success of the process is set.

Upon receiving the Delete Reply packet, AFC daemon-1 transmits the Delete Reply packet to AFC daemon-ini (step S271).

Upon receiving the Delete Reply packet, AFC daemon-ini transmits a Delete Reply message in the same format as the Delete Reply packet to the Initiator application (step S272).

As a result of the process above, AFC daemon-ini holds the same tables as in FIG. 8. AFC daemon-1 holds the same tables as in FIG. 46. AFC daemon-2 holds the same tables as in FIG. 47.

(Security Procedure in AFC)

(Connectionless AFC Architecture (without Manager))

(Preconditions for Security Measures)

The security measures in AFC according to the present embodiment will now be described. It is assumed that a secure communication path such as a Transport Layer Security (TLS) connection can be established between a Requester Application and an AFC Daemon operating on an AF node. It is also assumed that a secure communication path such as a TLS connection can be established between an AFC Daemon and an AAA Server.

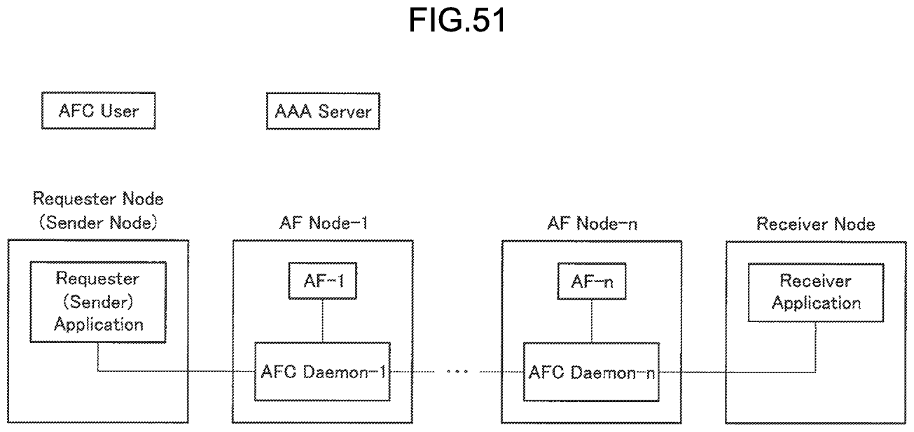

FIG. 51 is a diagram illustrating a Connectionless AFC architecture without an AFC Manager. An application requesting setting or deletion of an AF is termed Requester Application, and the node on which the Requester Application operates is termed Requester Node. The user initiating a Requester Application is termed AFC User. The process of transmitting data to be applied to AFC is termed Sender Application, and the node on which the Sender Application operates is termed Sender Node. The process of receiving a packet from the Sender Application through AFC is termed Receiver Application, and the node on which the Receiver Application operates is termed Receiver Node. In a case of two-way communication, both processes are a Sender Application and a Receiver Application. A Sender Application may be a Requester Application, and a Receiver Application may be a Requester Application. FIG. 51 illustrates an example in which a Requester Application is a Sender Application. The node on which an AF operates is termed AF Node. At an AF Node, a daemon process called AFC Daemon-p always operates. In FIG. 51, the description of AFC Daemon-p is omitted. When a Requester Application requests for installation of an AF, AFC Daemon-p initiates an AFC Daemon as a child process, and thereafter the AFC Daemon performs the process. An Authentication, Authorization, and Accounting (AAA) Server is introduced as a function of performing authentication and authorization as to whether the AFC User initiating a Requester Application has the authority to use the AF.

The overall operation of Connectionless AFC is as follows. The Requester Application installs a desired AF at a desired AF Node. For example, it is assumed that AF-1, AF-2, and AF-3 are installed at AF Node-1, AF Node-2, and AF Node-3, respectively.

It is assumed that the Requester Application is a Sender Application. The Sender Application may select any of the already installed AF-1, AF-2, and AF-3 and use them in any order to configure AFC. For example, AFC may be configured in the order of Sender Application, AF-1, AF-3, and Receiver Application.

The Sender Application specifies an AF to pass through, in the header of the data packet during data transmission, whereby AFC is implemented.

Requester Application deletes the AF which is no longer in use.

(Security Measures in Installation of AF)

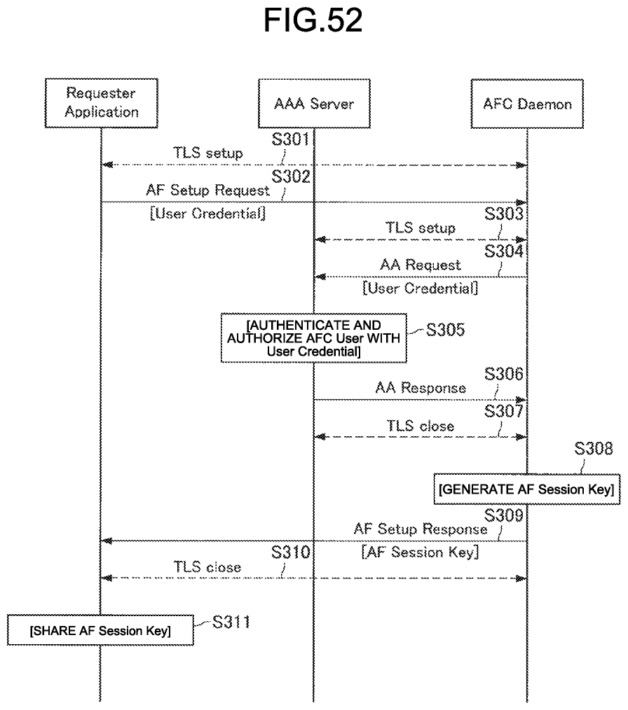

FIG. 52 is a diagram illustrating security measures in installation of an AF.

The Requester Application establishes a TLS connection with an AFC Daemon (step S301).

Subsequently, the Requester Application transmits an AF installation request packet (AF Setup Request packet) including authentication and authorization information (User Credential) to the AFC Daemon (step S302). An example of User Credential may be a set of user name and password of the AFC User.

The AFC Daemon receiving the AF installation Request packet establishes a TLS connection with the AAA Server (step S303).

Subsequently, the AFC Daemon transmits, to the AAA Server, an authentication and authorization request packet (AA Request packet) including User Credential (step S304).

The AAA Server verifies User Credential and performs authentication and authorization of the AFC User that has initiated the Requester Application (step S305). The authentication and authorization of the AFC User is verification of the authenticity of the AFC User that has initiated the Requester Application and verification of the authority to install and use a specific AF on a specific AF Node.

Upon execution of authentication and authorization of the AFC User, the AAA Server returns an authentication and authorization response packet (AA Response packet) to the AFC Daemon (step S306).

The AFC Daemon receiving the authentication and authorization response packet disconnects the TLS connection with the AAA Server (step S307).

If authentication and authorization is successful, the AFC Daemon initiates the specified AF (omitted in FIG. 52). Next, the AFC Daemon generates and stores an AF Session Key (step S308). The AF Session Key may be generated by any method. The AF Session Key may be, for example, a random number having a predetermined bit length.

The AFC Daemon returns an AF initiation Response packet (AF Setup Response packet) including the AF Session Key to the Requester Application (step S309).

The Requester Application receiving the AF initiation Response packet disconnects the TLS connection with the AFC Daemon (step S310).

The Requester Application stores the AF Session Key to share the AF Session Key with the AFC Daemon (step S311).

As described above, only the Requester Application initiated by the authorized AFC User can install an AF. That the Requester Application has the authority to install and use an AF is shared as information that is the AF Session Key between the Requester Application and the AFC Daemon. The AF Session Key is generated for each installed AF.

If authentication and authorization of the AFC User is failed at step S305, the AAA Server describes information that authentication and authorization is failed in the AA Response packet, which is in turn returned to the AFC Daemon. The AFC Daemon receiving the information that authentication and authorization is failed neither initiates the specified AF nor executes generation of an AF Session Key. The AFC Daemon then describes information that initiation of an AF is failed in the AF Setup Response packet, which is in turn returned to the Requester Application.

(Security Measures in AFC Data Packet Forwarding)

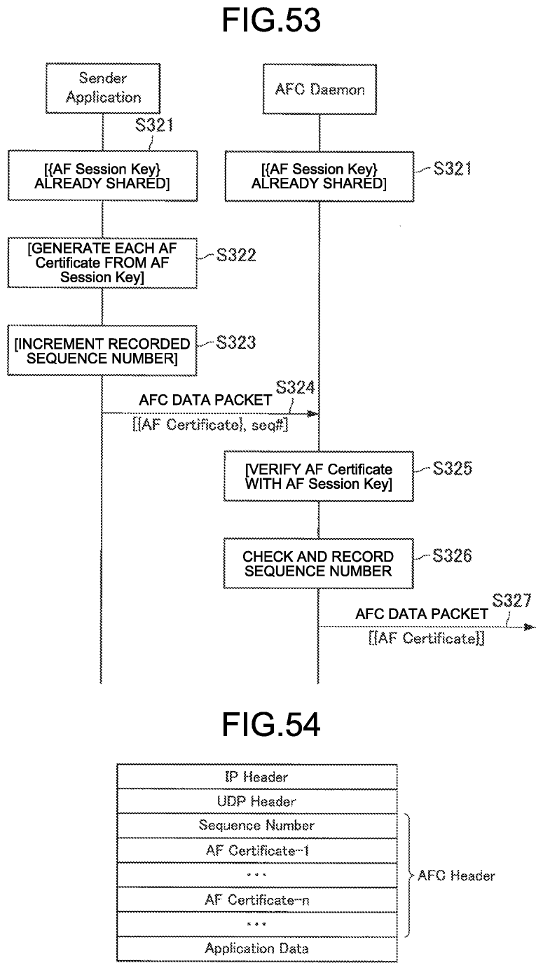

The security measures in AFC data packet forwarding will now be described. FIG. 53 is a diagram illustrating security measures in data packet forwarding on AFC. The Sender Application transmits an AFC data packet illustrated in FIG. 54. The AFC data packet includes an IP header, a UDP header, an AFC header, and application data. The AFC header includes a sequence number and an AF Certificate for each AF that constitutes AFC.

Through the process illustrated in FIG. 52, the Sender Application (Requester Application) and each AFC Daemon that constitutes AFC share an AF Session Key (step S321).

The Sender Application generates AF Certificates for all the AFs that constitute AFC (step S322). The AF Certificate is certification information generated from the AF Session Key. The method of generating an AF Certificate is not limited to a particular method. For example, as a possible method, the identifier of the AF and the AF Session Key are concatenated into a bit string, to which a hash function is applied, resulting in a bit string.

The Sender Application has a sequence number recorded therein, and increments the recorded sequence number when transmitting an AFC data packet (step S323).

The Sender Application includes all the generated AF Certificates and the sequence number into the header and transmits the AFC data packet (step S324).

The AFC Daemon receiving the AFC data packet verifies the corresponding AF Certificate using the AF Session Key (step S325). If verification is failed, the AFC Daemon determines that the AFC data packet is unauthorized and discards the received AFC data packet.

The AFC Daemon has a sequence number recorded therein for each Sender Application. The AFC Daemon checks the sequence number included in the header of the AFC data packet. If the sequence number in the header is equal to or smaller than the recorded sequence number, the packet is determined to be an unauthorized packet due to a replay attack and then discarded. The replay attack is an attack made by a malicious user who taps and records a legitimate AFC data packet and later transmits the AFC data packet. If not, the sequence number included in the header is recorded (step S326). Next, the AFC Daemon applies an AF to the AFC data packet (omitted in FIG. 53).

Subsequently, the AFC Daemon forwards the data packet to the next AF Node in accordance with the header (step S327).

Through the operation as described above, AFC is applied only to the AFC data packet transmitted by the Sender Application having the authority. The operation as described above also can prevent an attack (replay attack) by a malicious user who taps and records a legitimate AFC data packet and later transmits the AFC data packet.

(Security Measures in Deletion of AF)

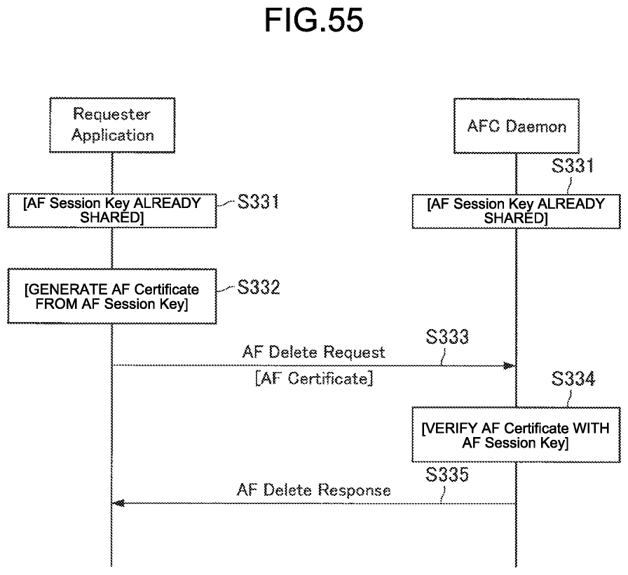

The security measures in deletion of an AF will now be described. FIG. 55 is a diagram illustrating security measures in deletion of an AF.

Through the process illustrated in FIG. 52, the Requester Application shares an AF Session Key with the AFC Daemon that has installed an AF (step S331).

The Requester Application generates an AF Certificate from the AF Session Key (step S332). The method of generating an AF Certificate is not limited to a particular method. For example, as a possible method, the identifier of the AF and the AF Session Key are concatenated into a bit string, to which a hash function is applied, resulting in a bit string.

The Requester Application transmits an AF deletion request packet (AF Delete Request packet) including the AF Certificate (step S333).

Upon receiving the AF deletion request packet, the AFC Daemon verifies the AF Certificate (step S334). If verification is successful, the AFC Daemon deletes the AF based on the AF deletion request packet (omitted in the figure).

Upon deleting the AF, the AFC Daemon transmits an AF deletion response packet (AF Delete Response packet) to the Requester Application (step S335).

Through the operation described above, only the Requester Application having the authority can delete an AF.

If verification of the AF Certificate is failed at step S334, the AFC Daemon does not execute deletion of the AF. The AFC Daemon then describes information of AF Certificate verification failure or AF deletion failure in the AF Delete Response packet, which is in turn transmitted to the Requester Application.

(Connectionless AFC Architecture (with Manager))

(Preconditions for Security Measures)

The security procedure with an AFC Manager will now be described. It is assumed that a secure communication path such as a TLS connection can be established between the Requester Application and the AFC Manager. It is assumed that a secure communication path such as a TLS connection is set in advance between the AFC Manager and the AAA Server. It is assumed that a secure communication path such as a TLS connection can be established between the AFC Manager and the AFC Daemon.

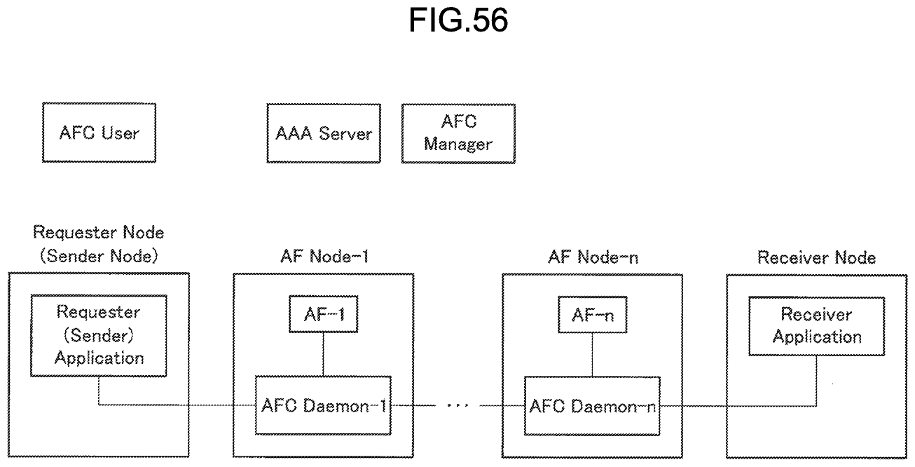

FIG. 56 illustrates a Connectionless AFC architecture with an AFC Manager. The architecture differs from the architecture illustrated in FIG. 51 only in that the AFC Manager is added.

(Security Measures in Installation of AF)

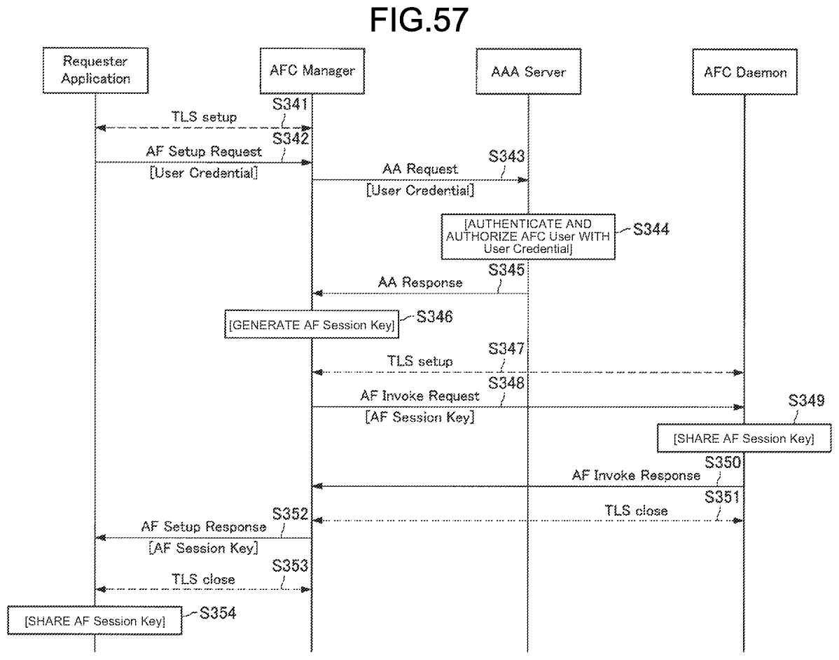

First, the security measures in installation of an AF will be described. FIG. 57 is a diagram illustrating security measured in installation of an AF.

The Requester Application establishes a TLS connection with the AFC Manager (step S341).

Subsequently, the Requester Application transmits an AF installation request packet (AF Setup Request packet) including authentication and authorization information (User Credential) to the AFC Manager (step S342). An example of User Credential may be a set of user name and password of the AFC User.

Upon receiving the AF installation request packet, the AFC Manager transmits an authentication and authorization request packet (AA Request packet) including User Credential to the AAA server (step S343).

The AAA Server verifies User Credential and performs authentication and authorization of the AFC User that has initiated the Requester Application (step S344). The authentication and authorization of the AFC User is verification of the authenticity of the AFC User that has initiated the Requester Application and verification of the authority to install and use a specific AF on a specific AF Node.

Upon executing authentication and authorization of the AFC User, the AAA Server transmits an authentication and authorization response packet (AA Response packet) to the AFC Manager (step S345).

If authentication and authorization is successful, the AFC Manager generates an AF Session Key (step S346). The AF Session Key may be generated by any method. The AF Session Key may be, for example, a random number having a predetermined bit length.

Subsequently, the AFC Manager establishes a TLS connection with the AFC Daemon (step S347).

Subsequently, the AFC Manager transmits an AF initiation request packet (AF Invoke Request packet) including the AF Session Key to the AFC Daemon (step S348).

The AFC Daemon initiates the specified AF (omitted in the figure). Next, the AFC Daemon stores the AF Session Key to share the AF Session Key with the AFC Manager (step S349).

Subsequently, the AFC Daemon transmits an AF initiation response packet (AF Invoke Response packet) to the AFC Manager (step S350).

Upon receiving the AF initiation response packet, the AFC Manager disconnects the TLS connection with the AFC Daemon (step S351).

Subsequently, the AFC Manager returns a packet (AF Setup Response packet) including the AF Session Key and the AF installation result to the Requester Application (step S352).

Upon receiving the AF Setup Response packet, the Requester Application disconnects the TLS connection with the AFC Manager (step S353).

Subsequently, the Requester Application stores the AF Session Key to share the AF Session Key with the AFC Manager (step S354).

Through the operation described above, only the authorized Requester Application can install and use an AF. That the Requester Application has the authority to install and use an AF is shared as information that is the AF Session Key among the Requester Application, the AFC Manager, and the AFC Daemon. The AF Session Key is generated for each installed AF.

If authentication and authorization of the AFC User is failed at step S344, the AAA Server describes information that authentication and authorization is failed in the AA Response packet, which is in turn returned to the AFC Manager. The AFC Manager receiving the information that authentication and authorization is failed neither executes generation of an AF Session Key nor executes an AF installation request to the AFC Daemon. The AFC Manager then describes information that initiation of an AF is failed in the AF Setup Response packet, which is in turn returned to the Requester Application.

(Security Measures in AFC Data Packet Forwarding)

The security measures in AFC data packet forwarding with an AFC Manager are similar to the security measures in AFC data packet forwarding without an AFC Manager illustrated in FIG. 53.

(Security Measures in Deletion of AF)

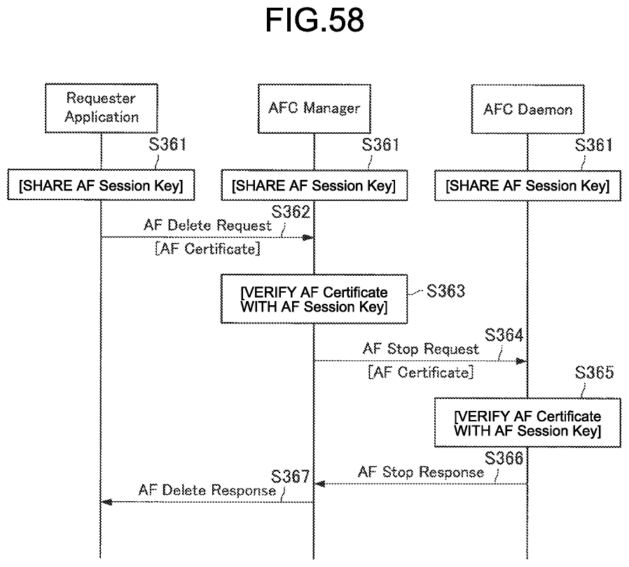

The security measures in deletion of an AF will now be described. FIG. 58 is a diagram illustrating security measures in deletion of an AF.

Through the process illustrated in FIG. 57, the Requester Application, the AFC Manager, and the AFC Daemon share an AF Session Key related to a deletion target AF (step S361).

The Requester Application transmits an AF deletion request packet (AF Delete Request packet) including the AF Certificate for the deletion target AF to the AFC Manager (step S362). The AF Certificate may be generated, for example, by concatenating the identifier of the AF and the AF Session Key into a bit string, to which a hash function is applied, resulting in a bit string.

Upon receiving the AF deletion request packet, the AFC Manager verifies the AF Certificate using the AF Session Key (step S363), and, if verification is successful, deletes the related information (omitted in FIG. 58).

Subsequently, the AFC Manager transmits an AF stop request packet (AF Stop Request packet) including the AF Certificate to the AFC Daemon (step S364).

The AFC Daemon verifies the AF Certificate included in the AF stop request packet, using the AF Session Key (step S365). If verification is successful, the AFC Daemon deletes the AF and deletes the related information (omitted in FIG. 58).

Subsequently, the AFC Daemon transmits an AF stop response packet (AF Stop Response packet) to the AFC Manager (step S366).

Upon receiving the AF stop response packet, the AFC Manager transmits an AF deletion response packet (AF Delete Response packet) to the Requester Application (step S367).

Through the operation described above, only the Requester Application having the authority can delete an AF.

If verification of the AF Certificate is failed at step S363, the AFC Manager does not delete the related information and does not execute an AF stop request to the AFC Daemon. The AFC Manager then describes information of AF Certificate verification failure or AF deletion failure in the AF Delete Response packet, which is in turn transmitted to the Requester Application.

(AFC for COTS Device)

(Architecture)

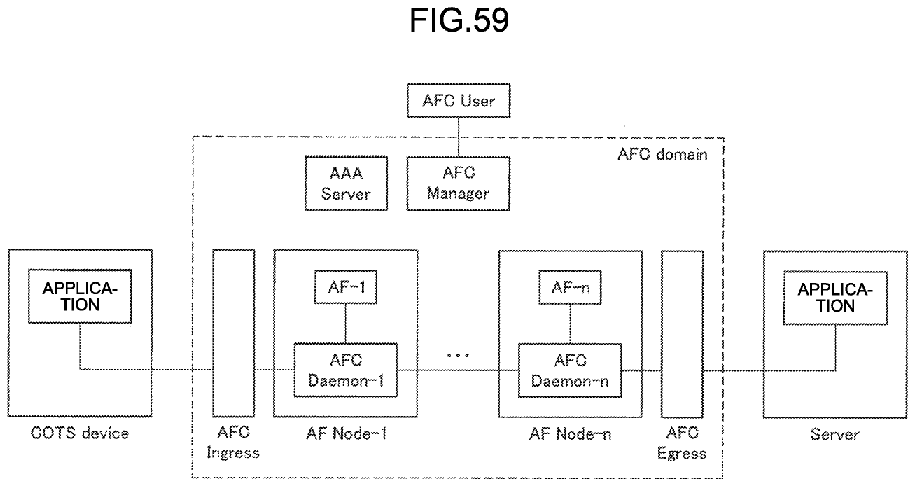

FIG. 59 is a diagram illustrating an architecture of AFC for commercial off-the-shelf (COTS) device. A COTS device is an off-the-shelf communication device, and it is assumed that the settings such as parameters can be changed but software change is not allowed.

A network domain in which AFC can be set is termed AFC domain. Nodes called AFC Ingress and AFC Egress are arranged on the boundary of the AFC domain. The AFC Ingress is a node serving as the entrance to the AFC domain for a data packet to which AFC is applied, and the AFC Egress is a node serving as the exit from the AFC domain. The AFC Manager is a node that manages AFC in the AFC domain. The AFC User is a user that installs AFC in the AFC domain. The AAA Server is a node that performs authentication and authorization of the AFC User. One or more AF Nodes exist in the AFC domain. The AF Node is a node that can execute an AF. At an AF Node, a daemon process called AFC Daemon-p always operates. In FIG. 59, the description of AFC Daemon-p is omitted. When the AFC User requests installation of an AF, AFC Daemon-p initiates an AFC Daemon as a child process, and thereafter the AFC Daemon performs the process. The Server is the other party that the COTS device communicates with. It is assumed that an application on the COTS device communicates with an application on the Server.

The overall procedure of applying AFC to communication between the application on the COTS device and the application on the Server is as follows.

The AFC User installs one or more AFs to be used in AFC at the desired AF Node. This operation is termed AF Setup.

The AFC User connects the installed AFs into a linear shape or a branched or merged shape and installs AFC. This operation is termed AFC Setup. In order to select a data packet to which AFC is to be applied, from among data packets transmitted by the application on the COTS device, a 5-tuple (start-point IP address, end-point IP address, protocol, start-point port number, end-point port number) is used.

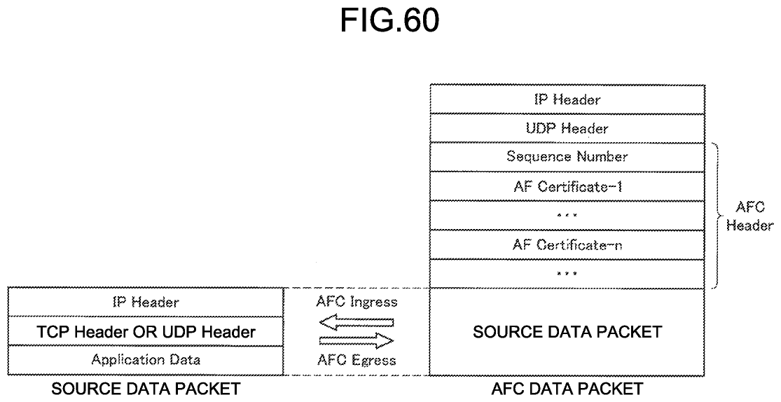

The application on the COTS device transmits a data packet via TCP/IP or UDP/IP. This packet is termed source data packet. The source data packet reaches the AFC Ingress. The AFC Ingress chooses AFC to be applied by the 5-tuple and adds an IP header, a UDP header, and an AFC header for implementing AFC to the received packet. This packet is termed AFC data packet. FIG. 60 is a diagram illustrating a structure example of the AFC data packet.

The AFC Ingress transmits the AFC data packet. The AFC data packet passes through the AF Nodes that constitute AFC, and an AF is applied to the source data packet at each AF Node. Finally, the AFC data packet reaches the AFC Egress.

The AFC Egress deletes the IP header, the UDP header, and the AFC header from the AFC data packet, extracts the source data packet, and transmits the source data packet.

Finally, the source data packet reaches the application on the Server.

The AFC User deletes AFC which is no longer in use. This operation is termed AFC Teardown.

The AFC User deletes the AF which is no longer in use. This operation is termed AF Teardown.

(Preconditions for Security Measures)

The preconditions for security measures in the architecture of AFC for COTS device will be illustrated. In order to ensure security, the present embodiment supposes the following. It is assumed that a secure communication path such as a TLS connection is preset between the AFC Manager and the AAA server. It is assumed that a TLS connection can be established, if necessary, between the AFC User and the AFC Manager, between the AFC Manager and the AFC Ingress, and between the AFC Manager and the AF Node. It is also assumed that a secure communication path can be established by an authentication scheme such as WPA2 in Wi-Fi between the COTS device and the AFC Ingress by parameter setting in the COTS device.

(Security Measures in Installation of AF)

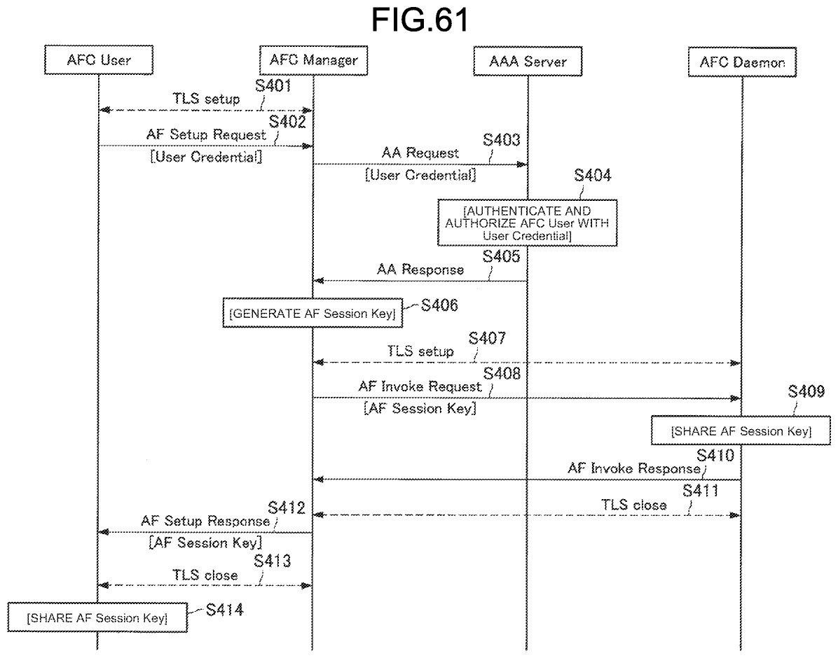

First, the security measures in installation of an AF will be described. FIG. 61 is a diagram illustrating security measures in installation of an AF.

First, a TLS connection is established between the AFC User and the FC Manager (step S401).

When the AFC User installs an AF at an AF Node, the AF User transmits an AF installation request packet (AF Setup Request packet) including authentication and authorization information (User Credential) to the AFC Manager (step S402).

Upon receiving the AF installation request packet, the AFC Manager transmits an authentication and authorization request packet (AA Request packet) including User Credential to the AAA server (step S403).

Upon receiving the authentication and authorization request packet, the AAA Server verifies User Credential included in the authentication and authorization request packet and performs authentication and authorization of the AFC User (step S404). The authentication and authorization of the AFC User is verification of the authenticity of the AFC User and verification of the authority of the AFC User to install and use a specific AF at a specific AF Node.

Subsequently, the AAA Server transmits an authentication and authorization response packet (AA Response packet) to the AFC Manager (step S405).

If authentication and authorization is successful, the AFC Manager generates an AF Session Key (step S406). The AF Session Key may be generated by any method. The AF Session Key may be, for example, a random number having a predetermined bit length.

Subsequently, the AFC Manager establishes a TLS connection with the AFC Daemon (step S407).

Subsequently, the AFC Manager transmits an AF installation request packet (AF Invoke Request packet) including an AF Session Key to the AFC Daemon (step S408).

Upon receiving the AF installation request packet, the AFC Daemon initiates the AF specified by the AF installation request packet (omitted in the figure). The AFC Daemon then stores the AF Session Key to share the AF Session Key with the AFC Manager (step S409).

Subsequently, the AFC Daemon transmits an AF installation response packet (AF Invoke Response packet) to the AFC Manager (step S410).

Upon receiving the AF installation response packet, the AFC Manager disconnects the TLS connection with the AFC Daemon (step S411).

Subsequently, the AFC Manager returns a packet (AF Setup Response packet) including the AF Session Key and the AF installation result to the AFC User (step S412).

Upon receiving the AF Setup Response packet, the AFC User disconnects the TLS connection with the AFC Manager (step S413).

Subsequently, the AFC User stores the AF Session Key to share the AF Session Key with the AFC Manager (step S414).

Through the operation described above, only the authorized AFC User can perform setting and use an AF. That the AFC User has the authority to install and use an AF is shared as information that is the AF Session Key among the AFC User, the AFC Manager, and the AFC Daemon. The AF Session Key is generated for each installed AF.

If authentication and authorization of the AFC User is failed at step S404, the AAA Server describes information that authentication and authorization is failed in the AA Response packet, which is in turn returned to the AFC Manager. The AFC Manager receiving the information that authentication and authorization is failed neither executes generation of an AF Session Key nor executes an AF installation request to the AFC Daemon. The AFC Manager then describes information that initiation of an AF is failed in the AF Setup Response packet, which is in turn returned to the AFC User.

(Security Measures in Installation of AFC)

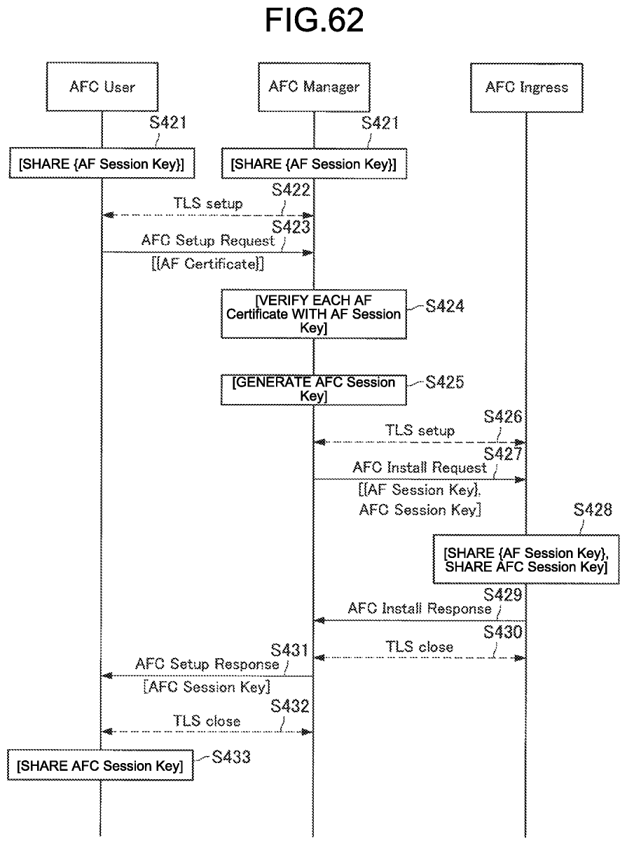

The security measures in installation of AFC will now be described. FIG. 62 is a diagram illustrating security measures in installation of AFC.

Through the process illustrated in FIG. 61, the AFC User and the AFC Manager share AF Session Keys for all the AFs that constitute AFC to be installed (step S421).

The AFC User establishes a TLS connection with the AFC Manager (step S422).

Subsequently, the AFC User transmits an AFC installation request packet (AFC Setup Request packet) including AF Certificates for all the AFs that constitute AFC to the AFC Manager (step S423). The AF Certificate is certification information generated from the AF Session Key. The AF Certificate may be generated, for example, by concatenating the identifier of the AF and the AF Session Key into a bit string, to which a hash function is applied, resulting in a bit string.

Upon receiving the AFC Setup Request packet, the AFC Manager verifies the AF Certificate using the AF Session Key held by the AFC Manager, for all the AFs included in the AFC Setup Request packet (step S424).

If verification of the AF Certificate is successful for all the AFs included in the AFC Setup Request packet, the AFC Manager generates an AFC Session Key (step S425). The AFC Session Key may be generated by any method. The AFC Session Key may be, for example, a random number having a predetermined bit length.

Subsequently, the AFC Manager establishes a TLS connection with the AFC Ingress (step S426).

Subsequently, the AFC Manager transmits an AFC installation request packet (AFC Install Request packet) including the AF Session Keys for all the AFs included in the AFC Setup Request and the AFC Session Key, to the AFC Ingress (step S427).

Upon receiving the AFC installation request packet, the AFC Ingress stores AFC installation information (omitted in the figure) and stores the AF Session Keys for all the AFs that constitute AFC and the AFC Session Key to share these Keys with the AFC Manager (step S428).

Subsequently, the AFC Ingress transmits an AFC installation response packet (AFC Install Response packet) to the AFC Manager (step S429).

Upon receiving the AFC installation response packet, the AFC Manager disconnects the TLS connection with the AFC Ingress (step S430).

Subsequently, the AFC Manager returns a packet (AFC Setup Response packet) including the result of the AFC installation process and the AFC Session Key to the AFC User (step S431).

Upon receiving the AFC Setup Response packet, the AFC User disconnects the TLS connection with the AFC Manager (step S432).

Subsequently, the AFC User stores the AFC Session Key to share the AFC Session Key with the AFC Manager (step S433).

Through the operation above, when the AFC User installs AFC, the authority of the AFC User is confirmed. The AFC Session Key is generated for each AFC and shared among the AFC User, the AFC Manager, and the AFC Ingress. The AF Session Key is shared with the AFC Ingress in addition to the AFC User, the AFC Manager, and the AFC Daemon.

If verification of one or more AF Certificates is failed at step S424, the AFC Manager does not execute an AFC installation request to the AFC Ingress. The AFC Manager then describes information of AF Certificate verification failure or AFC installation failure in the AFC Setup Response packet, which is in turn transmitted to the AFC User.

(Security Measures in AFC Data Packet Forwarding)

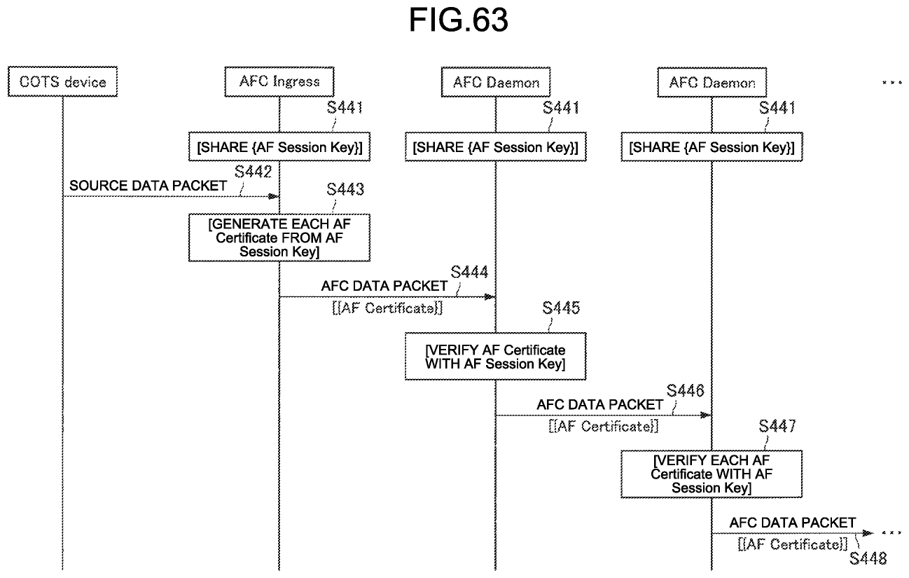

The security measures in AFC data packet forwarding will now be described. FIG. 63 is a diagram illustrating security measures in AFC data packet forwarding.

Through the process illustrated in FIG. 61 and FIG. 62, the AF Session Key held by the AFC Daemon in which each AF that constitutes AFC operates is shared with the AFC Ingress (step S441).

First, the COTS device transmits a source data packet (step S442).

When receiving a source data packet and transmitting an AFC data packet, the AFC Ingress generates an AF Certificate from the AF Session Key for each AF that constitutes AFC and includes the AF certificate into the AFC header (step S443). The AF Certificate may be generated, for example, by concatenating the sequence number, the identifier of the AF, and the AF Session Key into a bit string, to which a hash function is applied, resulting in a bit string.

Subsequently, the AFC Ingress transmits the AFC data packet to the AFC Daemon (step S444).

Upon receiving the AFC data packet, the AFC Daemon verifies the AF Certificate for the AF operating on the AFC Daemon (step S445). This process is performed in the corresponding AFC Daemon on which each AF that constitutes AFC operates.

Upon verifying the AF Certificate, the AFC Daemon forwards the AFC data packet to the next AFC Daemon that constitutes AFC (step S446).

Similar processing is performed thereafter (steps S447, S448).

Through the process above, even when an unauthorized node forges and transmits an unauthorized AFC data packet to an AF Node, the AFC Daemon can detect that the AFC data packet is unauthorized. When receiving a source data packet and transmitting an AFC data packet, the AFC Ingress increments the sequence number for each packet and includes the incremented sequence number into the AFC header. The sequence number is allocated for each AFC. On the other hand, the AFC Daemon has the sequence number of the received AFC data packet. Accordingly, even if an unauthorized node taps and stores a legitimate AFC data packet and later transmits the tapped packet (replay attack), the AFC Daemon can detect the replay attack. If the sequence number is additionally used as described above in generating an AF Certificate, the forged sequence number can also be detected. When an unauthorized AFC data packet is detected, the AFC Daemon discards the AFC data packet.

If verification of the AF Certificate is failed at step S445, the AFC Daemon discards the AFC data packet without forwarding the AFC data packet to the next AFC Daemon that constitutes AFC. This is applicable when verification of the AF Certificate is failed at step S447.

(Security Measures in Deletion of AFC)

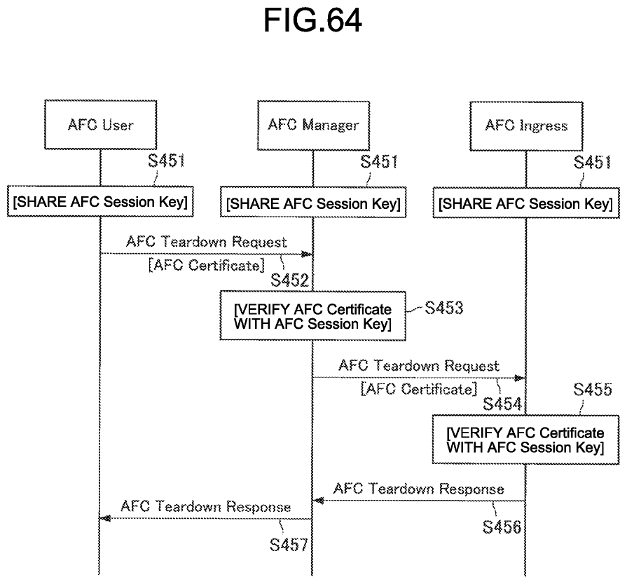

The security measures in deletion of AFC will now be described. FIG. 64 is a diagram illustrating security measures in deletion of AFC.

Through the process illustrated in FIG. 62, the AFC User, the AFC Manager, and the AFC Ingress share the AFC Session Key for the deletion target AFC (step S451).

The AFC User transmits an AFC deletion request packet (AFC Teardown Request packet) including an AFC Certificate to the AFC Manager (step S452). The AFC Certificate may be generated, for example, by concatenating the identifier of the AFC and the AFC Session Key into a bit string, to which a hash function is applied, resulting in a bit string.

Upon receiving the AFC deletion request packet, the AFC Manager verifies the AFC Certificate and confirms that the AFC User has the authority for the target AFC (step S453).

Subsequently, the AFC Manager forwards the AFC Teardown Request packet to the AFC Ingress (step S454).

Upon receiving the AFC Teardown Request packet, the AFC Ingress verifies the AFC Certificate (step S455), confirms that the AFC User has the authority for the target AFC, and deletes the settings of the AFC (omitted in the figure).

Subsequently, the AFC Ingress transmits the AFC Teardown Response packet to the AFC Manager (step S456).

The AFC Manager forwards the AFC Teardown Response packet to the AFC User (step S457). Through the operation described above, only the AFC User having the authority can delete AFC.

If verification of the AFC Certificate is failed at step S453, the AFC Manager does not execute an AFC deletion request. The AFC Manager then describes information that verification of the AFC Certificate is failed in the AFC Teardown Response packet, which is in turn returned to the AFC User.

(Security Measures in Deletion of AF)

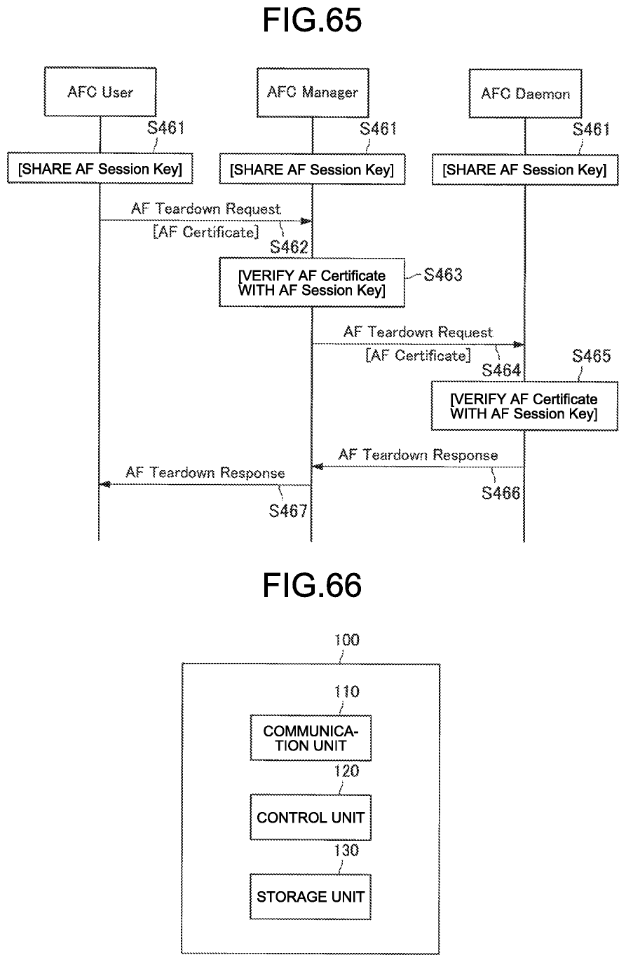

The security measures in deletion of an AF will now be described. FIG. 65 is a diagram illustrating security measures in deletion of an AF.

Through the process illustrated in FIG. 61, the AFC User, the AFC Manager, and the AFC Daemon share the AF Session Key for the deletion target AF (step S461).

The AFC User transmits an AF deletion request packet (AF Teardown Request packet) including the AF Certificate for the deletion target AF to the AFC Manager (step S462). The AF Certificate may be generated, for example, by concatenating the identifier of the AF and the AF Session Key into a bit string, to which a hash function is applied, resulting in a bit string.

Upon receiving the AF deletion request packet, the AFC Manager verifies the AF Certificate using the AF Session Key (step S463) and, if verification is successful, deletes the related information (omitted in the figure).

Subsequently, the AFC Manager forwards the AF Teardown Request packet to the AFC Daemon (step S464).

Upon receiving the AF Teardown Request packet, the AFC Daemon verifies the AF Certificate using the AF Session Key (step S465). If verification is successful, the AFC Daemon deletes the AF and deletes the related information (omitted in the figure).

Subsequently, the AFC Daemon transmits an AF Teardown Response packet to the AFC Manager (step S466).

The AFC Manager forwards the AF Teardown Response packet to the AFC User (step S467).

Through the operation described above, only the AFC User having the authority can delete an AF.

If verification of the AF Certificate is failed at step S463, the AFC Manager does not delete the related information and does not execute an AF deletion request. The AFC Manager then describes failure in verification of the AFC Certificate in the AF Teardown Response packet, which is in turn returned to the AFC User.

An embodiment of the present disclosure has been described above. A functional configuration example of a communication device that may function as each node according to an embodiment of the present disclosure will now be described.

FIG. 66 is a diagram illustrating a functional configuration example of a communication device 100 that may function as each node according to an embodiment of the present disclosure. The communication device 100 illustrated in FIG. 66 includes a communication unit 110, a control unit 120, and a storage unit 130.

The communication unit 110 executes communication between nodes. Communication between nodes may be wired or wireless. The communication unit 110 transmits and receives packets and messages described above to a predetermined port and from a predetermined port of another node under the control of the control unit 120.

The storage unit 130 stores a variety of information and computer programs used in the AFC architecture described above. For example, the storage unit 130 stores a variety of tables described above.

The control unit 120 executes a process based on the AFC architecture described above. For example, the control unit 120 performs, for example, setting of a path (AFC Path) to/from a target node, communication processing with a target node, processing in adding, changing, or deleting an AF node, initiation of an AFC-daemon, and execution of the function of an AF.

### 2. CLOSING

As explained above, an embodiment of the present disclosure provides the communication device 100 that enables one or more functions desired by a service user to act on a packet desired by the service user, in a service of forwarding packets in a network.

The steps in a process executed by a device in the present description are not necessarily processed in chronological order in the order described in a sequence diagram or a flowchart. For example, the steps in a process executed by a device may be processed in an order different from the order described in a flowchart or may be processed concurrently.

For example, a computer program may be created which causes hardware such as CPU, ROM, and RAM contained in a device to fulfill the functions equivalent to the configuration of the device as described above. A recording medium encoded with the computer program may also be provided. The functional blocks illustrated in a functional block diagram may be implemented by hardware whereby a series of processes are implemented by hardware.

Although a preferred embodiment of the present disclosure has been described in detail above with reference to the accompanying drawings, the technical scope of the present disclosure is not limited to such embodiments. It is obvious that one having ordinary knowledge in the technical field of the present disclosure would conceive a variety of changes or modifications without departing from the technical idea recited in the claims, and it should be understood that these changes and modifications naturally pertain to the technical scope of the present disclosure.

The effects described in the present description is only by way of explanation or illustration and is not intended to be limitative. The technique according to the present disclosure may achieve other effects apparent to those skilled in the art from the disclosure in the present description, in addition to or instead of the effects described above.

The following configuration may fall within the technical scope of the present disclosure.

(1)

A communication device comprising:

a communication unit configured to execute communication with another node; and

a control unit configured to control communication by the communication unit, wherein

the control unit generates path information to a target node, and

in the path information to a target node, at least information on communication with at least one relay node present on a path to the target node and information on a function to be executed by the relay node are described.

(2)

The communication device according to (1), wherein the control unit generates new path information when the path information to a target node is changed.

(3)

The communication device according to (2), wherein the control unit generates new path information when path information is changed in order to insert a new relay node on a path to the target node.

(4)

The communication device according to (2), wherein the control unit generates new path information when path information is changed in order to split a path to the target node.

(5)

The communication device according to (2), wherein the control unit generates new path information when path information is changed in order to establish a path to a new target node.

(6)

The communication device according to (2), wherein the control unit generates new path information when path information is changed in order to delete the relay node on a path to the target node.

(7)

The communication device according to any one of (1) to (6), wherein the communication unit transmits the path information generated by the control unit to a first relay node described in the path information.

(8)

The communication device according to any one of (1) to (7), wherein when the path information is generated, the control unit includes information on authentication and authorization into a description of the path information.

(9)

The communication device according to (8), wherein when communication directed to the target node is executed, the control unit executes an authentication process using the information on authentication and authorization.

(10)

A communication device comprising:

a communication unit configured to execute communication with another node; and

a control unit configured to control communication by the communication unit, wherein

the control unit refers to path information sent from another node and determines whether the communication device is a target node or a relay node,

when the communication device is a target node, the control unit returns a response to a node that has transmitted the path information, and

when the communication device is a relay node, the control unit launches a function included in the communication device based on information described in the path information.

(11)

The communication device according to (10), wherein the control unit executes a process of establishing a connection with another node based on the path information.

(12)

The communication device according to (11), wherein when the communication unit receives new path information, the control unit executes a process of establishing a connection or a process of disconnecting a connection based on the new path information.

(13)

The communication device according to any one of (10) to (12), wherein the control unit holds information on authentication and authorization included in the path information.

(14)

The communication device according to (13), wherein when communication directed to the target node is executed, the control unit executes an authentication process using the information on authentication and authorization.

(15)

A data structure for use in a communication device,

the communication device including
a communication unit configured to execute communication with another node, and
a control unit configured to control communication by the communication unit,

the data structure comprising, as path information between the communication device and a target node, at least information on communication with at least one relay node present on a path to the target node and information on a function to be executed by the relay node.

(16)

The data structure according to (15), further comprising, as the path information, information for splitting and merging a path between the communication device and the target node.

(17)

A communication method comprising:

executing communication with another node; and

controlling the communication with another node, wherein

control of the communication with another node includes generating path information to a target node, and

in the path information to a target node, at least information on communication with at least one relay node present on a path to the target node and information on a function to be executed by the relay node are described.

(18)

A communication method comprising:

executing communication with another node; and

controlling the communication with another node, wherein

control of the communication with another node includes referring to path information sent from another node and determining whether a communication device is a target node or a relay node, and

when the communication device is a target node, a response to a node that has transmitted the path information is returned, as control of the communication with another node,

when the communication device is a relay node, a function included in the communication device is launched based on information described in the path information, as control of the communication with another node.

(19)

A computer program causing a computer to execute:

executing communication with another node; and

controlling the communication with another node, wherein

control of the communication with another node includes generating path information to a target node, and

in the path information to a target node, at least information on communication with at least one relay node present on a path to the target node and information on a function to be executed by the relay node are described.

(20)

A computer program causing a computer to execute:

executing communication with another node; and

controlling the communication with another node, wherein

control of the communication with another node includes referring to path information sent from another node and determining whether a communication device is a target node or a relay node,

when the communication device is a target node, a response to a node that has transmitted the path information is returned, as control of the communication with another node, and

when the communication device is a relay node, a function included in the communication device is launched based on information described in the path information, as control of the communication with another node.

### REFERENCE SIGNS LIST

100 communication device
110 communication unit
120 control unit
130 storage unit

1. A communication device comprising:
a communication unit configured to execute communication with another node; and
a control unit configured to control communication by the communication unit, wherein
the control unit generates path information to a target node, and
in the path information to a target node, at least information on communication with at least one relay node present on a path to the target node and information on a function to be executed by the relay node are described.

2. The communication device according to claim 1, wherein the control unit generates new path information when the path information to a target node is changed.

3. The communication device according to claim 2, wherein the control unit generates new path information when path information is changed in order to insert a new relay node on a path to the target node.

4. The communication device according to claim 2, wherein the control unit generates new path information when path information is changed in order to split a path to the target node.

5. The communication device according to claim 2, wherein the control unit generates new path information when path information is changed in order to establish a path to a new target node.

6. The communication device according to claim 2, wherein the control unit generates new path information when path information is changed in order to delete the relay node on a path to the target node.

7. The communication device according to claim 1, wherein the communication unit transmits the path information generated by the control unit to a first relay node described in the path information.

8. The communication device according to claim 1, wherein when the path information is generated, the control unit includes information on authentication and authorization into a description of the path information.

9. The communication device according to claim 8, wherein when communication directed to the target node is executed, the control unit executes an authentication process using the information on authentication and authorization.

10. A communication device comprising:
a communication unit configured to execute communication with another node; and
a control unit configured to control communication by the communication unit, wherein
the control unit refers to path information sent from another node and determines whether the communication device is a target node or a relay node,
when the communication device is a target node, the control unit returns a response to a node that has transmitted the path information, and
when the communication device is a relay node, the control unit launches a function included in the communication device based on information described in the path information.

11. The communication device according to claim 9, wherein the control unit executes a process of establishing a connection with another node based on the path information.

12. The communication device according to claim 11, wherein when the communication unit receives new path information, the control unit executes a process of establishing a connection or a process of disconnecting a connection based on the new path information.

13. The communication device according to claim 10, wherein the control unit holds information on authentication and authorization included in the path information.

14. The communication device according to claim 13, wherein when communication directed to the target node is executed, the control unit executes an authentication process using the information on authentication and authorization.

15. A data structure for use in a communication device,
the communication device including
a communication unit configured to execute communication with another node, and
a control unit configured to control communication by the communication unit,
the data structure comprising, as path information between the communication device and a target node, at least information on communication with at least one relay node present on a path to the target node and information on a function to be executed by the relay node.

16. The data structure according to claim 15, further comprising, as the path information, information for splitting and merging a path between the communication device and the target node.

17. A communication method comprising:
executing communication with another node; and
controlling the communication with another node, wherein
control of the communication with another node includes generating path information to a target node, and
in the path information to a target node, at least information on communication with at least one relay node present on a path to the target node and information on a function to be executed by the relay node are described.

18. A communication method comprising:
executing communication with another node; and
controlling the communication with another node, wherein
control of the communication with another node includes referring to path information sent from another node and determining whether a communication device is a target node or a relay node, and
when the communication device is a target node, a response to a node that has transmitted the path information is returned, as control of the communication with another node,
when the communication device is a relay node, a function included in the communication device is launched based on information described in the path information, as control of the communication with another node.

19. A computer program causing a computer to execute:
executing communication with another node; and
controlling the communication with another node, wherein
control of the communication with another node includes generating path information to a target node, and
in the path information to a target node, at least information on communication with at least one relay node present on a path to the target node and information on a function to be executed by the relay node are described.

20. A computer program causing a computer to execute:
executing communication with another node; and
controlling the communication with another node, wherein
control of the communication with another node includes referring to path information sent from another node and determining whether a communication device is a target node or a relay node,
when the communication device is a target node, a response to a node that has transmitted the path information is returned, as control of the communication with another node, and
when the communication device is a relay node, a function included in the communication device is launched based on information described in the path information, as control of the communication with another node.
